(19) United States
(12) Patent Application Publication
(10) Pub. No.: US 2024/0309119 A1
(43) Pub. Date: Sep. 19, 2024

(54) METHOD

(71) Applicant: ALGINOR ASA, Haugesund (NO)

(72) Inventors: Ricky Lee GREEN, Haugesund (NO); Kurt Ingar DRAGET, Trondheim (NO)

(21) Appl. No.: 18/576,908

(22) PCT Filed: Jul. 6, 2022
(86) PCT No.: PCT/GB2022/051743

§ 371 Date: Jan. 5, 2024

(30) Foreign Application Priority Data
Jul. 6, 2021 (GB) 2109772.0

(51) Int. Cl. C08B 37/00

(52) U.S. Cl. CPC C08B 37/0003; C08B 37/0084

(57) ABSTRACT

The invention provides a method for obtaining alginate from macroalgae. in particular from brown seaweed such as Laminaria hyperborea. It further relates to alginate obtained by such a method. More particularly. the invention provides a method for the extraction of alginate from macroalgae. or a part thereof. said method comprising the following steps: (i) contacting macroalgae. or a part thereof, with an aqueous solution of a weak organic acid such as lactic acid, malic acid, tartaric acid, citric acid, ascorbic acid or glycolic acid: (ii) subsequently contacting the macroalgae. or part thereof, with an aqueous solution of a mineral acid whereby to form a pre-treated macroalgae material: and (iii) extracting alginate from said pre-treated macroalgae material. Such a method is capable of producing alginate that is light in colour without the need to use toxic chemicals such as formaldehyde. The method can be controlled to adjust the final composition of the extracted alginate. for example its molecular weight. polydispersity. its viscosity when dissolved in water or its M/G ratio. This allows the production of alginate having properties tailored according to its intended application.

### FIELD OF THE INVENTION

The present invention relates to a method of processing macroalgae and to products produced by such a method. More specifically, it relates to a method of obtaining alginate from macroalgae, in particular from brown macroalgae such as Laminaria hyperborea. It further relates to alginate obtainable, obtained or directly obtained by such a method.

In certain aspects, the invention relates to improvements in and relating to the extraction of alginate compared to methods currently used in industrial processing of macroalgae. Improvements include, but are not limited to, enhanced quality and/or yield of alginate and enhanced sustainability of the method. Advantageously, the method produces alginate that is light in colour without the need to use highly toxic chemicals such as formaldehyde. A reduction in CO₂ emissions and the ability to perform the method at ambient temperature additionally provides a more environmentally acceptable process than that currently used in industry.

In certain aspects, the invention further relates to a method of processing macroalgae that can be controlled to adjust the final composition of the extracted alginate. For example, its molecular weight and/or its M/G ratio may be adjusted so that the functional properties of the extracted alginate material, such as its viscosity when dissolved in water, its gelling capability, etc., can be tailored depending on its intended application.

### BACKGROUND OF THE INVENTION

Macroalgae, also known as “seaweed”, is a source of commercially useful products for use in a variety of applications, for example in the food, cosmetics and pharmaceutical industries, as well as in agriculture and in animal feed. To obtain such products, it is generally necessary to process the macroalgae and, in many cases, to extract the products. This is the case for alginate which is a polysaccharide that can be extracted from brown macroalgae. Alginate is the main structural component of the cell wall of the kelp Laminaria hyperborea and is present at high concentrations in the main stem (the “stipe”) and in the leaf (the “frond”).

“Alginate” is a term generally used in the industry to refer to alginic acid and any derivative of alginic acid, such as the salts of alginic acid. Alginates are made up of linear chains formed from two monomers, namely β-D-mannuronic acid (M) and α-L-guluronic acid (G) residues. The M and G monomers are covalently linked to form a linear copolymer. There are three types of segments in the linear structure: M blocks which consist of continuous M units, G blocks which consist of continuous G units, and MG blocks which contain heterogeneous or alternating M and G units. Alginate is present in the cell walls of brown seaweeds in the form of insoluble salts of alginic acid with multi-valent cations, such as calcium or aluminium. Mainly it is present as the calcium salt of alginic acid. Potassium and sodium salts may also be present. Sodium alginates are water-soluble polymers which give highly viscous solutions. In the presence of multi-valent cations, such as calcium, sodium alginate has the ability to form a gel. Divalent cations such as calcium ions bind G-blocks of aligned alginate chains giving rise to cross-linking between separate alginate chains or within the same alginate chain. This process gives rise to a gel-network.

Alginates have beneficial uses in many industries such as, for example, in the pharmaceutical, medical, nutraceutical and health, agricultural, cosmetics, food, paper and textiles industries. For example, alginate is used in wound dressings due to its hypoallergenic properties. Further uses include as a thickening, emulsifying or stabilising agent in foods, and as a weight loss supplement. Alginate is also a useful product for paper manufacturing and printing.

Alginates are conventionally extracted from brown macroalgae as the soluble sodium salt. Conversion of insoluble calcium alginate into soluble sodium alginate renders the alginate “extractable”. The method of extraction impacts the chemical and mechanical properties of the alginate and determines its use. The properties of the alginate, for example its viscosity when dissolved in water or the strength of the gel obtained on the addition of calcium salts, are determined by its molecular weight, the arrangement of the M and G residues in the polymer chains, and the overall M/G ratio of the alginate chain. In the presence of Ca²⁺ ions, for example, the G-blocks form ionic complexes to generate a cross-linked structure known as the “egg-box model” which is responsible for strong gel formation. The proportion of the M, G and MG blocks determines the physical properties of alginates. Alginates with high G have higher gelling properties, whereas those with high M are preferred for use as viscosity modifiers as they do not form strong gels in the presence of multi-valent cations. Alginates with high M/G ratios provide elastic gels, whereas those with low M/G ratios generate brittle gels. The M/G ratio can be altered by chemical or enzymatic modification of the alginate. The arrangement of the M and G residues and the overall M/G ratio can be altered by the extraction process. The different uses for alginates often require that these have certain predictable chemical and physical properties, for example molecular weight range and distribution, purity, viscosity, M and G content, M/G ratio, etc. G-rich alginates are particularly useful for pharmaceutical applications, for example.

The native alginate present in macroalgae has a high molecular weight and contains multi-valent cations, both of which render it insoluble. The aim of the extraction process is to obtain dry, powdered alginate, typically sodium alginate, ideally in high yield and having a high molecular weight, and which has minimal colour. Extraction of alginate generally requires a multi-stage process which involves treatment in acid solution, typically hydrochloric or sulphuric acid, to convert the native alginate to alginic acid followed by treatment with sodium carbonate to convert the insoluble alginic acid to soluble (i.e. extractable) sodium alginate. Treatment with sodium hydroxide at high pH (typically pH 11 or higher) and heat may also be required to facilitate hydrolysis of the alginate chains to reduce their molecular weight to the point where they become soluble. The result of the process is a viscous fluid which requires ‘thinning’ (e.g. by dilution in water) to allow filtration to separate the soluble alginate from the remaining seaweed residue. The dissolved alginate is then recovered from the aqueous solution, for example by adding acid to precipitate alginic acid, by adding a calcium salt to precipitate calcium alginate (from any alginate fragments that contain G-blocks), or by adding an anti-solvent such as ethanol.

The current “industry standard” process for the production of sodium alginate from brown macroalgae relies on the use of highly caustic solutions containing around 4 wt. % sodium carbonate, in addition to sodium hydroxide, to reduce the molecular weight of the native alginate chains and to convert the insoluble alginate (e.g. calcium alginate) to the corresponding soluble sodium form. These chemicals are used in excess. The process is thus wasteful in terms of the amount of chemicals which are used. Typical yields of alginate are also low, for example in the range of 15 to 20 wt. % (dry weight basis). As part of the alginate recovery process, excessive amounts of CO₂ are also released when the sodium carbonate is neutralised.

For use in many of its industrial applications, alginate which is colourless or light in colour is required so that the products to which it is added are not tainted by the colour of the alginate. A particular problem when extracting alginate from macroalgae, in particular brown macroalgae, is unwanted colour in the extracted product. Most of the colour in the stipe of the macroalgae is caused by the presence of coloured compounds (i.e. pigments) such as polyphenols (e.g. phlorotannins), carotenoids and chlorophyll which are mainly present in the outermost surface layer of the stipe (i.e. the “bark”). When the macroalgae is processed as a whole, or when using the intact stipe, these compounds which give rise to colour are incorporated into the alginate extraction process and form a non-reversible, coloured alginate solution following its extraction.

Traditionally, the problem of unwanted colour has been dealt with either by preventing its extraction using formaldehyde/formalin (which acts as a colour fixing agent by complexing with the pigments and making them insoluble) or by the use of chemical bleaching agents, such as hypochlorite bleaches. Formaldehyde also acts as a preservative and is often used after harvesting and prior to processing to prevent microbial degradation of the macroalgae. However, the use of formaldehyde is regulated due to its toxicity to humans and animals, and there is a general need to reduce its use and that of chemical bleaching agents in order to provide a process which is more sustainable and environmentally acceptable. The use of these agents in the production of alginate material that is to be ingested by humans or animals or which is to be used on a human or animal body is particularly undesirable. The presence of formaldehyde in the macroalgae residue remaining after alginate extraction also reduces its commercial value and it is treated as a waste material which is disposed of without attempting the recovery of other potentially useful materials, such as cellulose for example.

An alternative to the use of formaldehyde and chemical bleaching agents to deal with the problem of unwanted colour when extracting alginate from macroalgae is suggested in WO 2015/067971 (Marine Biopolymers Ltd.). This earlier application proposes that the outer surface layer of the stipe is removed by mechanical peeling or abrasion prior to extraction of alginate. Whilst this partly addresses the colour problem, however, the need to peel or abrade the stipe not only adds additional processing steps which increases the cost of the process, but is also wasteful in that the whole stipe is not utilised. Mechanical peeling is also difficult to control when performed on a stipe which is not uniform in diameter along its length and so the process must inevitably remove a greater thickness of the stipe than is strictly necessary to deal with the problem of colour. This is also not ideal since the stipe section just below the bark contains the “high-G” alginate which is of particular commercial value. Pigments, such as polyphenols, are also present to some extent throughout the entire stipe structure. Removal of the outer surface layer of the stipe does not address the problem of colour that arises from these.

### SUMMARY OF THE INVENTION

The present invention provides an alternative method for obtaining alginate or alginate-containing material from macroalgae which addresses or mitigates at least some of these problems. In at least certain aspects the invention provides an improved method over those conventionally known and used in the art, in particular those used to process macroalgae on an industrial scale.

Proposed herein is a method for the production of alginate which involves pre-treatment of the macroalgae prior to carrying out extraction, i.e. prior to conversion of the alginate present in the macroalgae into a soluble (i.e. extractable) form which can be extracted and recovered. The pre-treatment involves exposing the macroalgae, or part thereof, to a weak organic acid and subsequent cation exchange with a mineral acid. These pre-treatment steps are also referred to herein as a “pre-extraction” stage of the method and are highly effective to convert the native alginate (e.g. calcium alginate) to alginic acid. Subsequent treatment of the macroalgae material, for example with an alkaline solution, typically an alkaline sodium-containing solution such as sodium carbonate, in an “extraction” stage forms a water-soluble salt of the alginate (e.g. sodium alginate). This can then be recovered using conventional methods. Significantly, a much lower concentration of sodium carbonate can be used for extraction compared to that used in current industrial methods. This leads to reduced CO₂ emissions. In the method herein described, sodium hydroxide may also be used as a replacement for sodium carbonate thereby providing a zero CO₂ emission profile for the extraction part of the process.

Significantly, yet unexpectedly, the yield of alginate produced using the “pre-extraction” treatment herein described is higher than that obtained using conventional industrial methods without compromising the quality of the alginate, for example its viscosity when dissolved in water. A light coloured alginate is also produced without the need to use formaldehyde, formalin or any chemical bleaching agents and, most surprisingly, without the need to remove the pigment-containing bark from the stipe. The whole stipe can therefore be used without producing significant quantities of waste material, and allows direct access to other materials derived from the remaining residues. The “pre-extraction” stage of the method can additionally be controlled to recover alginate material having predictable and desired functional properties. Advantageously, the method herein described therefore enables the properties of the extracted alginate to be tailored according to its intended use.

In one aspect, the invention provides a method for the extraction of alginate from macroalgae, or a part thereof, said method comprising the following steps:
(i) contacting macroalgae, or a part thereof, with an aqueous solution of a weak organic acid;
(ii) subsequently contacting the macroalgae, or part thereof, with an aqueous solution of a mineral acid whereby to form a pre-treated macroalgae material; and
(iii) extracting alginate from said pre-treated macroalgae material.

In another aspect, the invention provides alginate, or an alginate derivative, obtained, obtainable, or directly obtained from the method herein described. In particular, it provides sodium alginate obtained, obtainable, or directly obtained from the method.

In a further aspect, the invention provides products comprising the alginate or alginate derivative as herein described, for example products comprising sodium alginate. Such products include, but are not limited to, food products, pharmaceuticals, medical products, nutraceutical and health products, products for use in agriculture, cosmetic products, and products for use in the paper and textiles industries.

### DETAILED DESCRIPTION OF THE INVENTION

As used herein, and unless otherwise specified, the term “alginate” is broadly used to refer not only to alginic acid salts (which may be referred to in the art as “alginates”), but to any other derivative of alginic acid and alginic acid itself. As noted herein, alginic acid is a polysaccharide consisting of blocks of (1-4)-linked β-D-mannuronate (M), α-L-guluronate (G) and blocks having an alternating structure (MG). Any reference herein to “native insoluble alginate” is intended to refer to alginate in its naturally occurring form, in particular calcium alginate. Where reference is made to a “soluble alginate”, it will be understood that this refers to a soluble form, for example the soluble sodium form. It may, however, also refer to any other mono-ion form that is soluble such as potassium alginate or ammonium alginate. As will be understood, any reference herein to a “soluble alginate” refers to an alginate that is soluble in water. An “insoluble alginate” will be understood to refer to an alginate that is insoluble in water, such as an insoluble salt of alginic acid with a multi-valent cation, such as calcium or aluminium. Typically, the native insoluble alginate will comprise calcium alginate. Examples of soluble alginates include sodium alginate, potassium alginate and ammonium alginate. Typically, the soluble alginate will be sodium alginate. Any “soluble” form of alginate may also be referred to herein as “extractable alginate”, i.e. it can be extracted from the macroalgae by direct solubilisation.

The terms “macroalgae” and “seaweed” are used interchangeably herein and are intended to refer to any species of macroscopic, multi-cellular, marine algae. Any macroalgae which contains alginate may be used in the method of the invention. Brown macroalgae, such as kelp, are known to contain a high concentration of alginate and are particularly suitable. The term “kelp” refers to large brown macroalgae which form part of the order Laminariales. Macroalgae suitable for use in the invention include, but are not limited to, those selected from the group consisting of Laminaria spp, Ascophyllum spp, Durvillaea spp, Ecklonia spp, Lessonia spp, Macrocytis spp and Sargassum spp. Examples of particular species include Laminaria hyperborea, Laminaria digitata, Lessonia trabeculata, Lessonia flavicans and Lessonia brasiliensis. Laminaria spp are particularly suitable, such as Laminaria hyperborea.

Macroalgae typically comprise three distinct morphological parts or sections: the frond (also known as the “leaf” or “blade”), the stipe (a ‘stem-like’ structure), and the haptera (a ‘root-like’ structure which anchors the macroalgae to the ocean floor and which is also sometimes referred to as the “holdfast”). These parts are different in terms of their physical properties and chemical composition. Harvesting methods involve cutting of the stipe close to the holdfast. Following harvesting the frond and stipe will typically be separated from one another to form the different “parts”. Whilst the method herein described may be performed in respect of the whole macroalgae (i.e. the stipe and frond), typically it will be carried out in respect of one or more separated parts. Where separated parts are used together in the method of the invention, these may be combined in any desired ratio depending on the desired properties of the extracted alginate. For example, a combination of separated leaf and stipe may be employed, e.g. in a 50:50 weight ratio. The size of the macroalgae or part thereof will typically be reduced to increase its surface area prior to processing in accordance with the method of the invention. Suitable methods are described herein.

Alginate is concentrated in the stipe of macroalgae. In one embodiment, the method will be performed on the stipe of the macroalgae which contains the highest alginate content. The macroalgae part which is used in the method of the invention may therefore comprise substantially only the stipe. Use of the stipe of Laminaria hyperborea is particularly preferred. Alternatively, the method of the invention may be performed on the frond of the macroalgae, or on part of the frond. Where part of the frond is used, this will generally be the thickest part taken from the base of the frond. Use of the frond, or any part of the frond, of Laminaria hyperborea is preferred. Alternatively, the method of the invention may be performed in respect of the whole macroalgae, for example a combination of both the stipe and the frond.

Selection of the appropriate part (or parts) of the macroalgae for use in the method will influence the physicochemical properties of the material that is obtained and can be selected accordingly.

Epiphytes are organisms that grow on the surface of macroalgae in the marine environment. These include other species of algae, bacteria, fungi, sponges, bryozoans, ascidians, protozoa, crustaceans, molluscs and other sessile organisms. It may be beneficial for these to be removed (or substantially removed) prior to use of the macroalgae, or any part of the macroalgae, in a method as herein described. Where it is desirable to remove epiphytes from the surface of the macroalgae or part thereof, any conventional method may be used. These may be removed by washing with water, for example using high pressure water jets. In some embodiments, however, the epiphytes need not be removed. The macroalgae, or part thereof, which is used in the method of the invention may therefore carry epiphytes on its surface.

The stipe of the macroalgae may be selected for use in the method of the invention due to its higher alginate content and its higher proportion of G-blocks than in the leaf (i.e. higher G/M ratio). The stipe may be substantially cylindrical and comprises three distinctive regions defined based on their radial distance from the centre axis of the stipe. The radially inner portion comprises a core region of the stipe referred to as the “inner core”; the radially intermediate portion surrounding the core comprises a tissue region referred to as the “outer core”; and the radially outermost portion comprises a protective surface layer which may be referred to as the “outer layer”. This outer layer may also be referred to as the “bark”, “peel” or “skin” of the stipe.

The stipe may be processed to remove some or all of its outer surface layer prior to treatment in accordance with the method herein described. However, in a preferred embodiment of the invention, it need not be removed. This is particularly advantageous. Stipe which has not been subjected to any chemical or physical process to remove the outermost surface layer, i.e. in which the outer layer remains substantially “intact”, is particularly preferred for use in the method of the invention. Such a stipe may be referred to as “unpeeled” stipe. In one set of embodiments, therefore, the macroalgae for use in the method may be whole macroalgae (i.e. stipe and frond) in which the stipe retains the outer surface layer, or stipe which has been separated from the leaf but which still retains the outer surface layer. The use of unpeeled stipe of Laminaria hyperborea is particularly preferred for use in the invention.

Although generally less desirable, it is possible to carry out the method herein described in respect of a stipe from which the outermost layer has been substantially removed, i.e. “peeled” stipe. In an embodiment, the method may therefore comprise the step of removal of an outwardly facing surface layer from the stipe or sections of stipe which contains unwanted pigments such as polyphenols. The outwardly facing surface layer for removal will comprise at least the epidermis layer and may additionally comprise the meristoderm layer. Typically, the outwardly facing surface layer that is removed will include at least the epidermis and meristoderm layers. Removal of the surface layer may be carried out using any method known in the art. For example, it may be removed by a chemical stripping process or by a mechanical method. Mechanical methods include peeling, abrasion, scraping, or treatment with high pressure water jets. Peeling, abrasion or scraping may be done manually (i.e. by hand) but more typically will be carried out using an automated machine such as a peeling and/or abrading machine known in the art for peeling and/or abrading vegetables. Suitable peeling methods are described in WO 2015/067971, the entire contents of which are incorporated herein by reference. The thickness of the outwardly facing surface layer of the stipe to be removed will be dependent on the type, age and thickness (i.e. diameter) of the macroalgae but can readily be determined by those skilled in the art. The outwardly facing surface layer of the stipe that is removed may have a thickness of at least 0.5 mm, preferably at least 1.5 mm. For example, it may have a thickness in the range of from 0.5 mm to 2.5 mm.

The method herein described may be performed in respect of the whole (i.e. intact) macroalgae or in respect of a part thereof. For example, it may be carried out in respect of the stipe. Prior to carrying out the pre-extraction stage of the method, it is generally preferred that the macroalgae or part thereof will be reduced in size in order to increase its surface area and thus improve the efficiency of the treatment method. The method used to reduce its size is not of particular importance and any known method may be used to reduce the size of the material, i.e. to divide it into a plurality of portions such as a plurality of stipe portions. For example, the macroalgae or part thereof (e.g. the stipe or the frond) may be divided by any combination of cutting, chopping, flaking, blending, and milling. If appropriate, it may be cut into smaller sections prior to flaking, blending or milling. This may be useful to aid in handling of the material during the step of flaking, blending or milling.

In one embodiment, the macroalgae or part thereof may be divided into a plurality of portions by cutting followed by milling. Cutting may be appropriate to reduce the size of the macroalgae into smaller portions. For example, the stipe may be cut into lengths of from 5 to 100 mm, for example 5 to 10 mm.

Milling may be carried out using any conventional milling machine known in the art. If desired, milling may involve more than one milling stage involving the use of progressively finer screens to provide the desired particle size. Milled portions may have a particle size ranging from 0.1 mm to 10 mm, preferably from 1 mm to 5 mm, e.g. from 1 mm to 2 mm. In one embodiment, the milled portions may have a particle size in the range from 2 mm to 10 mm, e.g. from 4 mm to 8 mm.

The method herein described may comprise the further step of washing the macroalgae or part thereof with water prior to carrying out the pre-treatment step. For example, it may comprise the step of washing the plurality of macroalgae portions (e.g. the stipe and/or frond portions) with water. Deionised water may be used, but it is generally preferred that potable water (containing calcium ions) is used in order to reduce the loss of any low molecular weight “G” bearing alginate from the material.

Advantageously, washing with water removes salt and, in part, other unwanted water-soluble components such as polyphenols. One or more washing steps may be carried out, as desired. The temperature of the water and duration of washing may readily be determined by those skilled in the art. Lower temperatures and/or shorter treatment times are generally preferred to reduce the energy requirements of the process and to avoid any harsh treatment of the material that may adversely impact the extracted alginate material. When washing the macroalgae portions, water may be added to the portions which are then agitated in the water and then allowed to drain through a filter. If desired, any water-soluble materials may be recovered from the wash water. In one embodiment, no additional washing step is required at this point in the process.

The method described herein may be carried out in respect of macroalgae that is live or dead. For example, it may be carried out in respect of fresh, frozen or dried macroalgae or any part or parts thereof. A macroalgae that is “live” will retain some degree of biological activity such as respiration. In one embodiment, the method is carried out in respect of fresh macroalgae or a part thereof. By “fresh”, it is intended that the macroalgae or part thereof has not dehydrated to any appreciable extent following harvest. Fresh macroalgae includes live, harvested material, i.e. material that is a live respiring plant. Alternatively, following harvesting, the macroalgae or any part or parts thereof may be treated such that it no longer has any biological activity such as respiration. For example, the macroalgae may be pressed to remove seawater and thus reduce the volume of the plant material to aid in its transportation. Pressing may, in some cases, result in “dead” plant material. The macroalgae or any part or parts thereof may, alternatively, be frozen or dried. For example, it may be air dried at ambient temperature or at an elevated temperature, or it may be dried in a fluid bed dryer. Prior to drying, the macroalgae or part thereof will typically be shredded or flaked to reduce the energy requirement of the drying process. Following drying, it may be further shredded, flaked, or ground (e.g. by grinding or milling) to produce a material which can be stored prior to treatment in accordance with the method herein described. Any dried macroalgae material will typically be re-hydrated prior to subjecting it to the pre-extraction process as described herein. Addition of water to the dried material may also be beneficial to extract any water-soluble pigments which are not bound to the alginate chains (e.g. polyphenols), to remove unwanted salts and other low molecular weight components.

Re-hydration of any dried macroalgae material will typically be carried out by contacting the material with water. Similar to the washing step, deionised water may be used for the purpose of re-hydration, however it is generally preferred that potable water (containing calcium ions) is used in order to reduce the loss of any low molecular weight “G” bearing alginate from the material. The use of potable water also reduces the cost of the process when carried out on an industrial scale.

A suitable hydration ratio (wet mass: dry mass) may readily be determined but may, for example, be greater than about 8:1, preferably greater than 10:1. It may, for example be in the range from about 8:1 to about 12:1. Hydration may be carried out by adding the dried macroalgae material, for example dried flakes, to water, stirring and allowing to stand. It may be carried out in a continuous or batch-wise process. Multiple hydration steps may be conducted in which water is removed from the hydrated mass at the end of each step, the solid mass is collected and transferred to the subsequent hydration stage. This aids in removal of unwanted salts, water-soluble pigments and other constituents from the material. Hydration steps may be carried out until the conductivity of the water which is removed from the material is sufficiently reduced and indicative of the removal of a sufficient amount of unwanted salts from the material. A conductivity of less than about 200 μS for deionised water may, for example, be appropriate. For potable water, an acceptable conductivity may be its native conductivity +200 μS. The required hydration time is dependent on the particulate size of the dried material but can readily be determined by those of skill in the art. Hydration may take several hours. The final material will typically be treated to remove excess water prior to further processing. The hydrated mass may then be processed as described herein.

The pre-extraction stage of the method involves an initial step of contacting the macroalgae or part thereof with a weak organic acid as described herein. This step is effective to reduce the native alginate molecular weight and decolourise the material. Without wishing to be bound by theory, it is believed that the organic acid is effective to degrade any chlorophyll and pigment residues. Thereafter, the decolourised material is subjected to treatment with a mineral acid whereby to exchange the metal ions present in the alginate structure (e.g. calcium) with hydrogen ions in order to facilitate subsequent extraction.

The pre-extraction stage of the method may be limited to treatment of the macroalgae or part thereof with the organic acid and treatment with the mineral acid, i.e. no additional pre-treatment steps will be performed (aside from any size reduction of the macroalgae material and/or washing steps as herein described). However, in some embodiments, the pre-extraction stage may include additional pre-treatment steps such as those generally known and used in the art. Where these are carried out, these will typically be performed prior to contacting the macroalgae material with the organic acid. Additional pre-treatment steps may, for example, include methods known to adjust the M/G ratio of the alginate. For example, the macroalgae or part thereof may be subjected to an additional pre-treatment capable of enriching the G-content of the material (i.e. increasing the G/M ratio). Acid treatment at elevated temperature (e.g. using acids having a low pH such as mineral acids) may, for example, be performed to hydrolyse the “M” blocks and thereby enrich the G-content of the alginate. Such treatment is particularly suitable in the case of leaf alginate, for example, which is lower in G-content than alginate present in the stipe. Other known methods that may be employed to hydrolyse the “M” blocks include enzymatic treatment, for example using lyase enzymes. Suitable methods for enhancing the G-content of alginate include those described in EP 0 980 391, the entire contents of which are incorporated herein by reference.

In some embodiments, the method may comprise an additional pre-treatment step involving treatment with an alcohol, e.g. propan-2-ol. This may be beneficial when processing the leaf (i.e. frond) of the macroalgae to aid in the removal of coloured pigments. However, this step is not essential. As described herein, a light coloured alginate material can still be obtained from the leaf without the need to carry out this additional pre-treatment step. Any pigments removed in this step may, if desired, be recovered and purified as separate products.

In some embodiments of the invention, the method may comprise an additional pre-treatment step of contacting the macroalgae or part thereof with calcium ions. The addition of Ca²⁺ ions serves to bind the G-blocks in the alginate and protect them from degradation during subsequent processing. When carried out, this step will generally be performed prior to organic acid treatment. Calcium ions may be provided in the form of a calcium chloride solution, for example. A typical concentration of calcium chloride can readily be determined by those skilled in the art, but may be in the range of 0.5 to 10% w/v, preferably 1.0 to 7.5% w/v, for example 5.0% w/v.

In certain embodiments, any additional pre-treatment of the macroalgae that degrades the target alginate material to any significant extent should be avoided or at least minimised. Microwave treatment of macroalgae is conventionally used to break down complex polysaccharides into their corresponding monomers, for example in the production of biofuels. Such treatment should be avoided in the method of the invention. In one embodiment, the method herein described thus excludes any step involving exposure of any of the following materials to microwaves: the macroalgae, or part thereof, any of the intermediate products produced during the method, and the recovered alginate. Any harsh acid or alkaline treatment which hydrolyses the alginate chains to any significant extent should also be minimised (preferably avoided) to reduce the extent of degradation of the alginate chains and to avoid any reduction in its molecular weight.

As used herein, the term “organic acid” denotes an organic compound which has acidic properties. Organic acids for use in the invention may possess one or more acid groups.

As used herein, the term “weak organic acid” refers to a substance that partly dissociates when it is dissolved in a solvent, for example in water. The strength of an acid is measured by its acid dissociation constant, Kₐ, which can be determined experimentally by known methods such as titration. Weak acids have a lower Kₐ than strong acids and a higher pKₐ. pKₐ is the negative logarithm (to the base 10) of the dissociation constant (Kₐ) of an acid measured in an aqueous medium at a temperature of 25° C. Weak acids have a very low value for Kₐ (and therefore a higher value for pKₐ) compared to strong acids which have very high Kₐ values and slightly negative pKₐ values. An acid may have more than one dissociation constant depending on the number of protons that it can give up, and hence it may have more than one pKₐ value, denoted pKₐ₁, pKₐ₂, etc. pKₐ values of acids can readily be found in the literature, for example, in the CRC Handbook of Chemistry and Physics, 97th Edition, June 2016, Ed. William M. Haynes.

The organic acid for use in the invention should not induce acid hydrolysis of the alginate to any significant extent such that degradation of the alginate chains is minimised. Advantageously, the organic acid is selected based on its pKₐ value relative to that of alginic acid. Alginic acid has a pKₐ in the range of 1.5 to 3.5. In a preferred embodiment, the organic acid will have a pKₐ or, where appropriate, lowest pKₐ (i.e. “pKₐ₁”), which is greater than the lowest pKₐ of alginic acid.

Preferably, the organic acid will therefore have a pKₐ which is greater than 1.5.

Organic acids having a pKₐ (or, where appropriate, lowest pKₐ) in the range from 2 to 6, preferably from 2.5 to 5.5, more preferably from 3 to 5, e.g. from 3 to 4.5, are preferred for use in the invention.

In one embodiment, the organic acid for use in the invention will have a pKₐ (or, where appropriate, lowest pKₐ) that is less than or equal to the highest pKₐ of alginic acid. Organic acids having a pKₐ (or, where appropriate, lowest pKₐ) which is less than or equal to 3.5 are thus particularly preferred.

Suitable organic acids for use in the invention may readily be selected by those skilled in the art based on their pKₐ values. Where the alginate is intended for use in any pharmaceutical or food application, the organic acid should be selected accordingly. Food grade acids may therefore be appropriate, i.e. those which are acceptable for use in food products intended for human consumption. Typically it will be an organic acid which has been approved for use as a food additive by a food-related administration (e.g. the European Food Safety Authority, or the US Food and Drug Administration). Organic acids having an E-number and which are therefore permitted for use as food additives within the European Union are particularly suitable.

Organic acids which may be used in the invention include, for example, carboxylic acids. These may contain one or more carboxylic acid groups, i.e. these may be mono-or polycarboxylic acids. As used herein, the term “polycarboxylic acid” means a carboxylic acid containing at least two carboxylic acid functional groups (i.e. —COOH). The acid may, for example, be a mono, di-or tri-carboxylic acid.

In one embodiment, the organic acid may be a polycarboxylic acid, for example a di-or tri-carboxylic acid. Carboxylic acids having multiple carboxylic acid functional groups and which also have the capacity to chelate multi-valent cations, such as Ca²⁺ ions, may be particularly suitable. This includes, in particular, tri-carboxylic acids such as citric acid.

The carboxylic acid will typically be an aliphatic acid. It may be a linear, branched or cyclic aliphatic carboxylic acid, and it may be saturated or unsaturated.

Typically, the carboxylic acid will be saturated. The carboxylic acid may contain from 2 to 20 carbon atoms, for example. Optionally it may comprise one or more additional hydroxy groups. The aliphatic carboxylic acids may contain from 2 to 16 carbons, preferably from 2 to 14 carbon atoms, for example from 2 to 12 carbon atoms. The carboxylic acids may contain 2, 3, 4, 5, 6, 7, 8, 9, 10, 11 or 12 carbon atoms. Advantageously, the carboxylic acid may contain 4, 5, 6, 7, 8, 9 or 10 carbon atoms, for example 4, 5, 6, 7 or 8 carbon atoms. For example, the carboxylic acid may contain 4, 5 or 6 carbon atoms.

Carboxylic acids that also include hydroxy groups are particularly suitable for use in the invention. Carboxylic acids suitable for use in the invention thus include alpha-hydroxy acids. As used herein, the term “α-hydroxy acid” (or “AHA”) refers to a carboxylic acid substituted with a hydroxy group at the α-carbon atom. It includes lactones having a hydroxy group at the α-position and which may be saturated or unsaturated. Examples of AHAs provided in the form of a lactone include, but are not limited to, ascorbic acid. In addition to the hydroxy group at the α-carbon atom, an α-hydroxy acid or “AHA” as herein defined may contain one or more additional hydroxy groups.

In one embodiment, the carboxylic acid for use in the invention is a food grade AHA. Examples of suitable AHAs for use in the invention include lactic acid, malic acid, tartaric acid, citric acid, ascorbic acid, and glycolic acid. Of these, lactic acid (E270), malic acid (E296), tartaric acid (E334), citric acid (E330), and ascorbic acid (E300) have E-numbers and are generally preferred. Particularly preferred for use in the invention are malic, citric and ascorbic acids. The use of citric acid is especially preferred.

Examples of other carboxylic acids that may be used in the invention include, but are not limited to, acetic acid (E260) and formic acid (E326).

pKₐ values and, where appropriate, pKₐ₁ values of carboxylic acids suitable for use in the invention are as follows:

lactic acid: pKₐ=3.86

malic acid: pKₐ₁=3.40

tartaric acid: pKₐ₁=2.98

citric acid: pKₐ₁=3.13

ascorbic acid: pKₐ₁=4.17

glycolic acid: pKₐ=3.83

acetic acid: pKₐ=4.76

formic acid: pKₐ=3.75

Any pH and pKₐ values as referred to herein are as measured at ambient temperature, typically and preferably at 25° C.

The step of contacting the macroalgae or part thereof with the organic acid may be carried out in any known manner. For example, it may involve adding the aqueous solution of the acid to the macroalgae or part thereof and agitating to ensure good contact. Agitation may involve simple mixing or other techniques such as blending, high sheer mixing, etc. Suitable mixing ratios (macroalgae : organic acid) may readily be determined by those skilled in the art. Typically, the organic acid solution will be employed in excess to ensure good contact with the macroalgae and to aid in diffusion of the organic acid into the macroalgae. For example, a volume ratio of macroalgae : organic acid in the range of about 1:1.5 to about 1:5 or from about 1:2 to about 1:3 may be employed. A volume ratio of about 1:2 may be appropriate.

The precise conditions for the organic acid treatment, such as the concentration of the acid, temperature and duration of treatment, etc. can readily be selected by those skilled in the art taking into account factors such as the intended application of the extracted alginate material and its desired properties. As described herein, by varying the organic acid treatment conditions, the nature of the alginate obtained can be suitably adjusted. As evidenced in the examples, the duration of exposure of the macroalgae material to the organic acid, its concentration, and the temperature of the organic acid treatment have an impact on the molecular weight of the alginate that is extracted. This, in turn, intrinsically influences the viscosity of the alginate when dissolved in solution. Longer treatment times and/or higher temperatures are effective to reduce the molecular weight and viscosity of the alginate, for example. The use of higher concentrations of the organic acid also reduces the molecular weight (and thus viscosity) of the extracted alginate. Advantageously, the conditions of the organic acid pre-treatment can be adjusted to recover alginate having desired functional properties.

Typically, the organic acid may be employed in the form of an aqueous solution having a concentration of from 0.1 to 10.0% w/v, from 0.25 to 5.0% w/v, from 0.75 to 2.5% w/v, from 1.0 to 2.0% w/v, or from 1.0 to 1.5% w/v, preferably about 1% w/v. The use of a lower concentration of the organic acid may be preferred when it is desirable to provide an alginate having a higher molecular weight (and thus higher viscosity). Higher concentrations may be appropriate where a lower molecular weight (and thus lower viscosity) of the extracted alginate is desirable and may be selected accordingly. For example, an aqueous solution of the organic acid having a concentration in the range of from 5.0 to 10.0% w/v, from 6.0 to 10.0% w/v, or from 8.0 to 10.0% w/v may be employed.

The temperature of the organic acid treatment may be selected depending on the desired molecular weight (and thus viscosity) of the extracted alginate. Generally, temperatures up to about 100° C. may be employed. However, lower temperatures are generally preferred in order to reduce the overall energy requirement of the process. The use of lower temperatures may also provide a greater degree of control over the organic acid pre-treatment step (and thus its impact on the properties of the extracted alginate). Temperatures in the range from 10 to 100° C., preferably 10 to 50° C., more preferably 15 to 30° C., e.g. 20 to 25° C., may be employed. Advantageously, however, this step of the process will be conducted at ambient temperature, for example in the range from 18 to 25° C. As will be understood, ambient temperature does not require any additional heating. In one set of embodiments, the invention thus provides a method for the extraction of alginate from macroalgae, or a part thereof, said method comprising the following steps: (i) contacting macroalgae, or a part thereof, with an aqueous solution of a weak organic acid at ambient temperature, for example at a temperature of from 18 to 25° C.; (ii) subsequently contacting the macroalgae, or part thereof, with an aqueous solution of a mineral acid whereby to form a pre-treated macroalgae material; and (iii) extracting alginate from said pre-treated macroalgae material.

Higher temperatures for the organic acid treatment may be appropriate where a lower molecular weight (and thus lower viscosity) of the extracted alginate is desirable and may be selected accordingly. Where higher temperatures are used, these may be in the range from 60 to 100° C., for example from 65 to 100° C., from 70 to 100° C., from 80 to 100° C., from 90 to 100° C., or from 95 to 99° C. In another set of embodiments, the invention thus provides a method for the extraction of alginate from macroalgae, or a part thereof, said method comprising the following steps: (i) contacting macroalgae, or a part thereof, with an aqueous solution of a weak organic acid at a temperature of from 60 to 100° C.; (ii) subsequently contacting the macroalgae, or part thereof, with an aqueous solution of a mineral acid whereby to form a pre-treated macroalgae material; and (iii) extracting alginate from said pre-treated macroalgae material.

Duration of the organic acid treatment may be appropriately selected by those skilled in the art. For example, the timing of treatment may range from a few minutes to several hours. As will be understood, the duration for the treatment will be influenced by the selected concentration of the organic acid and the temperature employed in this step of the method. If a low concentration of organic acid is employed, the duration of treatment may for example extend to several days or even weeks. Typically, however, organic acid treatment may be carried out for up to 2 hours, for example up to 1.5 hours, e.g. up to 1 hour. Treatment may be carried out for shorter times, e.g. less than an hour, particularly in cases where elevated temperatures and/or higher concentrations of organic acid are employed. For example, treatment times may be as low as 2 minutes, or as low as 5 minutes. Treatment times may, for example, range from 2 to 60 minutes, or from 5 to 50 minutes, or from 10 to 40 minutes, or from 20 to 30 minutes.

Appropriate combinations of temperature and duration of the organic acid treatment may be selected by those skilled in the art. For example, treatment at ambient temperature for about 1 hour may be particularly suitable for the production of alginate having a high viscosity, for example a viscosity of greater than 800 cps, greater than 900 cps, greater than 1000 cps, greater than 1500 cps, greater than 1600 cps, greater than 1700 cps, greater than 1800 cps, or greater than 1900 cps. Where a higher temperature is employed, for example about 60° C., a treatment time in the range of about 5 to 10 minutes may be selected to produce alginate having a medium viscosity, for example a viscosity in the range from 400 to 800 cps, and a treatment time of about 30 to 40 minutes may be selected to produce an alginate having a low viscosity, for example a viscosity in the range from 50 to 400 cps. Where an ultra-low viscosity alginate is desired, a higher treatment temperature of up to about 100° C., for example about 95° C. to about 99° C., e.g. about 95° C., for a period of about 20 minutes may be suitable. A higher treatment temperature for a period of about 20 to 45 minutes, for example 35 to 40 minutes, may be appropriate to provide an ultra-low viscosity alginate. An ultra-low viscosity may be in the range from 5 to 50 cps. All viscosities referred to herein refer to the viscosity of a 1 wt. %

solution of alginate in water at 20° C. measured using a Brookfield-type viscometer.

Selection of the temperature and duration of the organic acid pre-treatment step of the method should take account of the concentration of the organic acid solution that is employed. When using higher concentrations of the organic acid, for example, shorter treatment times and/or lower temperatures may be appropriate in order to provide the desired degree of control in producing an extracted alginate having the required functional properties.

Following organic acid pre-treatment, the liquid will typically be separated from the macroalgae or part thereof, i.e. from the undissolved solids, for example by filtration or centrifugation. To improve the process efficiency, the filtrate or the liquid phase from the centrifuge can be collected and re-used in another pre-treatment process. Additional washing steps may be carried out at this stage, for example using deionised water.

Treatment with the organic acid is followed by a metal cation exchange step which is intended to convert insoluble alginate to alginic acid by exchanging metal cations with protons. In the method of the invention, this metal cation exchange step is carried out “subsequently” to the step of organic acid treatment. In this context, the term “subsequently” is not intended to exclude the option of one or more intermediate processing steps between step (i) and step (ii) of the method. Whilst step (ii) may immediately follow step (i), it need not. As detailed above, the organic acid pre-treatment step may, for example, be followed by separation of the treated macroalgae, or part thereof, from any liquid and, optionally, by subjecting the treated macroalgae, or part thereof, to one or more washing steps.

Step (ii) involves contacting the macroalgae, or part thereof, with an aqueous solution of a mineral acid to form a pre-treated macroalgae material. This is carried out by the addition of a mineral acid which is added to the reaction mixture to reduce the overall pH, for example to a pH in the range of about 1.5 to about 2, e.g. 1.7 to 1.9. Suitable mineral acids include hydrochloric acid and/or sulphuric acid. Conveniently, the mineral acid will be hydrochloric acid. More preferably, the mineral acid will be sulphuric acid. The material can be left to stand for up to 60 mins, for example up to 30 mins, for example up to approximately 15 minutes. As will be understood, the contact time will be dependent on the particle size of the material and can readily be selected by a person skilled in the art. During contact with the mineral acid, the mixture may be agitated (e.g. stirred). Generally, mineral acid treatment will be conducted at ambient temperature, i.e. at a temperature in the range from 18 to 25° C. If desired, the step of mineral acid treatment may be repeated.

Following mineral acid treatment, the method will then typically comprise the step of separating the resulting mixture into a solution phase and residual solids. For example, the material can then be drained through a filter or transferred to a centrifuge. The obtained gel or precipitate may be rinsed with water in one or more rinsing steps to remove excess mineral acid. The water for use in this part of the process will typically be deionised water in order to avoid the re-introduction of Ca²⁺ ions. Rinsing with water is effective to increase the pH of the material, e.g. to a pH in the range of from 4 to 5, and may be repeated as required. The filtrate or the liquid phase from the centrifuge, which is a mineral acid solution, may be collected and if desired can be used in a subsequent metal cation exchange step, thereby improving process efficiency.

Following the pre-treatment process which is described herein, the native alginate will be present in an insoluble form, i.e. primarily in the form of alginic acid. Calcium alginate residues may also still be present. The next step of the process is the “extraction step” which involves conversion of the insoluble alginate salts and/or alginic acid present in the macroalgae to the soluble form (e.g. the soluble sodium form) and its optional recovery.

Extraction of the alginate involves conversion of the insoluble alginate salts and/or alginic acid present in the macroalgae to the soluble sodium (or potassium) form which is extracted into solution for recovery. Methods for extracting alginate from macroalgae are well known in the art and any known method may be used to obtain the desired alginate following the pre-treatment process herein described.

Following extraction, the solubilised alginate can be separated (e.g. by filtration or centrifugation) from the residual solid components of the macroalgae and further processed to recover the alginate. For example, sodium, potassium or ammonium alginate may be recovered, e.g. in dry powdered form.

The step of extracting alginate from the macroalgae, or part thereof, may comprise contacting the macroalgae, or part thereof, with an alkaline solution, i.e. it is an alkaline extraction process. As used herein, the term “extraction” is intended to refer to a process that involves solubilisation of the alginate present in the macroalgae or part thereof in an insoluble form, typically as calcium alginate. Following extraction, some or all of the resulting solution containing the solubilised alginate may be separated (e.g. filtered) from the residual solid components of the macroalgae.

Typically, the alkali solution for use in the extraction may be selected from sodium hydroxide, potassium hydroxide, ammonium hydroxide and sodium carbonate. Conveniently, it may comprise carbonate ions, for example it may be a sodium carbonate solution. For example, the step of extracting alginate from the macroalgae, or part thereof, will comprise the use of sodium carbonate and/or sodium hydroxide, preferably sodium carbonate (e.g. a saturated sodium carbonate solution). The alkali solution, for example sodium carbonate, may be employed at a suitable concentration. Preferably, it will be used at low concentration. For example, it may be employed at a concentration of 0.05 to 4%, preferably 0.1 to 1% or 0.1 to 0.5%, for example about 0.25%. Conventional industrial methods for the production of alginate employ high concentrations of highly caustic materials to achieve the desired pH level (for example, in the region of pH 11 or 12) for the required molecular weight reduction of the native alginate and its extraction. The use of 4% sodium carbonate, in combination with sodium hydroxide, is typical and leads to high CO₂ emissions when neutralising the sodium carbonate in the alginate recovery process. The ability to use a much lower concentration of sodium carbonate in the method of the invention leads to a significant reduction in the emission of CO₂. It is estimated that the use of sodium carbonate at a concentration of 0.25% or lower, for example, results in at least 11 times less CO₂ per tonne of alginate produced. By effectively titrating the alginic acid with the sodium carbonate solution as also described herein, a further reduction in CO₂ emissions of up to 40 times can be achieved.

In one embodiment, sodium hydroxide may be employed instead of sodium carbonate in the alkaline extraction step. Advantageously, the use of sodium hydroxide gives rise to zero CO₂ emissions for this step of the process.

Contact with the alkali solution may comprise soaking of the macroalgae, or part thereof, in the alkali solution or it may involve mixing, e.g. high shear mixing, with the alkali solution. Soaking or mixing may be carried out for a period of about 2 minutes to about 24 hours, for example 30 minutes to 24 hours, for example 30 to 45 minutes. During contact, the pH should be kept in the range from about 7 to 9, preferably from about 7 to about 8.5, more preferably from about 7 to about 8, e.g. from about 7 to about 7.5. The pH may, for example, be maintained at 7, 7.1, 7.2, 7.3, 7.4 or 7.5. If necessary, additional alkali can be added as required. Reaction temperature and reaction time can readily be varied. For example, the reaction temperature may be in the range from 10 to 80° C., preferably 20 to 60° C., e.g. 20 to 30° C. or 40 to 60° C. Preferably, alkaline extraction will be carried out at ambient temperature, i.e. without any additional heating.

In one embodiment, the alkali solution is gradually added to the acidified macroalgae, or part thereof, until the pH has increased and is stable in the desired pH range, e.g. in the range from about 7 to about 9.5, preferably from about 7 to about 9, more preferably from about 7 to about 8.5, yet more preferably from about 7 to about 8, e.g. from about 7 to about 7.5. For example, the alkali solution may be added until the pH has increased to 7, 7.1, 7.2, 7.3, 7.4 or 7.5. Effective control of the pH during this step may achieved by gradual addition of the alkali solution with simultaneous monitoring of the pH, e.g. using a pH meter. In this way, the amount of added alkali solution effectively balances the amount of alginic acid present and, ideally, does not exceed more than is strictly necessary to achieve conversion of insoluble alginate into the soluble form (e.g. the sodium form). For example, the final concentration of alkali (e.g. sodium carbonate) may be about 0.1%. Stabilisation of the pH of the material is indicative of conversion of the alginate into the soluble form (e.g. sodium alginate). Minimising the pH reduces the extent of hydrolysis of the alginate chains.

The step of extracting alginate from the macroalgae, or part thereof, may further comprise the step of separating the solubilised alginate from the residual solids. Separation of the solubilised alginate from the residual solids may be carried out by known methods, for example by dilution with water (if necessary) and filtration, for example by centrifugation. These separation steps may be repeated, as desired. Any solids which are removed can be used for cellulose production, for example.

If desired, alginate can be recovered from any separated sodium (or potassium or ammonium) alginate solution using conventional methods such as the well-known “alginic acid” or “calcium alginate” methods which are described herein. Such methods are well known and described in the prior art, for example in McHugh (Dennis J. McHugh—Chapter 5 (Alginate) in “A guide to the seaweed industry”, FAO Fisheries Technical Paper 441, Food and Agriculture Organisation of the United Nations, 2003), the entire contents of which are incorporated herein by reference.

In the alginic acid method, the pH of the solution is adjusted by contacting with a mineral acid such as hydrochloric acid and/or sulphuric acid to form a precipitate of alginic acid. The acid may be employed in an amount and concentration sufficient to reduce the pH of the solution to about 2 or less, preferably between 1.7 and 1.9, whereby to form an alginic acid precipitate. Preferably, hydrochloric acid is used. The alginic acid precipitate is recovered in the form of a gel, for example by centrifugation. The resulting gel may optionally be rinsed with water to remove excess acid and to increase the pH to provide a solution having a pH of about 3.5 to about 4.0. If desired, the alginic acid gel may then be converted to sodium alginate by the addition of an alkali containing sodium ions, for example by the addition of a sodium carbonate solution. Addition should be carried out with continuous stirring. The amount and concentration of sodium carbonate solution can readily be adjusted but will typically be sufficient to adjust the pH of the solution to between 7.0 and 7.3. Other soluble alginate salts may alternatively be prepared using appropriate counter-ions. For example, potassium alginate may be prepared using an alkali containing potassium ions.

To recover the desired alginate product, the resulting solution may be contacted with an anti-solvent, such as an alcohol or mixture of alcohols, or acetone. Suitable alcohols include, for example, propan-2-ol and ethanol. This causes sodium alginate to be displaced from solution as a thick gel or precipitate. Subsequently, this precipitate can be removed from the solvent mixture, for example by centrifugation. The anti-solvent can be recovered and recycled, which improves process efficiency. The resulting alginate can then be dried, for example in a vacuum oven, for example at a temperature of up to 100°° C., for example up to 95° C., for example up to 85° C., for example up to 50° C., for example up to 30° C., preferably at 30° C.

In the “calcium alginate” method, calcium chloride is added to cause calcium alginate to precipitate or to form a gel, which can then be recovered. The pH of the precipitate or gel is then reduced to less than about 2.3 using a mineral acid such as hydrochloric and/or sulphuric acid. The resulting alginic acid precipitate or gel is recovered, for example by centrifugation. This may optionally be rinsed with water to remove excess acid and to increase the pH to provide a solution having a pH of about 3 to about 4. If desired, the alginic acid material may then be converted to sodium alginate by the addition of an alkali containing sodium ions, for example by the addition of a sodium carbonate solution. Addition may be carried out with stirring. The amount and concentration of sodium carbonate solution can readily be adjusted but will typically be sufficient to adjust the pH of the solution to between 7.0 and 7.3. Other soluble alginate salts may alternatively be prepared using appropriate counter-ions. For example, potassium alginate may be prepared using an alkali containing potassium ions. To recover the desired alginate product, the resulting solution may be contacted with an anti-solvent, such as an alcohol or mixture of alcohols, or acetone such as described above for the “alginic acid” method.

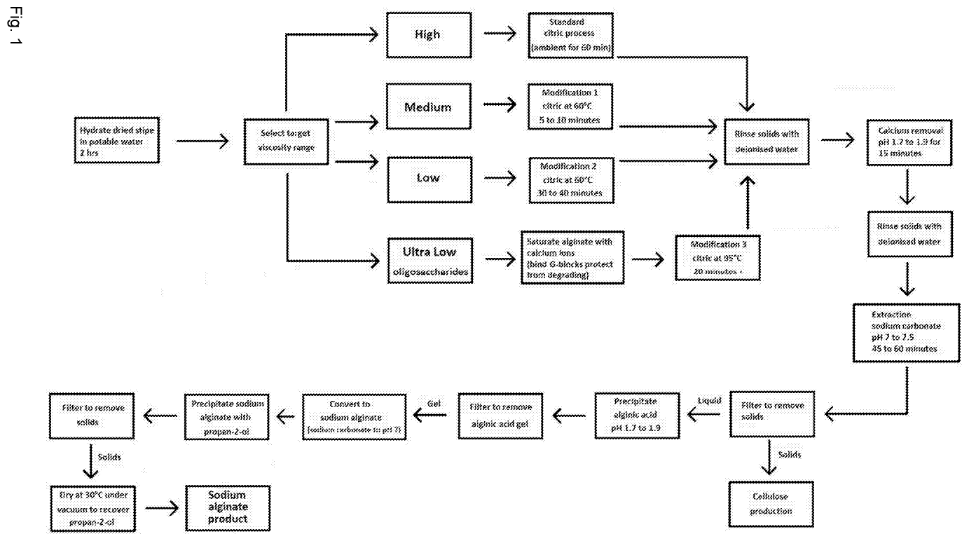

A specific embodiment of the method of the invention is described with reference to FIG. 1 using citric acid as the selected organic acid. In FIG. 1, the process involves obtaining macroalgae (Laminaria hyperborea) having a stipe and leaf and removing the non-stipe sections to provide a macroalgae part which consists of stipe only. The non-stipe parts are removed by manual or automated cutting, for example using a cutting machine generally used in the art. The stipe is then shredded and dried, for example by air-drying or fluid bed drying. Prior to the pre-treatment stage of the process, the dried stipe is re-hydrated in potable water for 2 hours. Salt and other unwanted water-soluble components, such as polyphenols, are extracted during the re-hydration process. The re-hydrated stipe is then separated from any residual water. At this point, the re-hydrated stipe is ready for the organic acid pre-treatment step.

As herein described, the method of the invention can readily be adapted to adjust the final properties of the alginate product. This is illustrated in FIG. 1 by the various modifications intended to produce alginate having the desired “high”, “medium”, “low” or “ultra-low” viscosity. A “high” viscosity may be greater than 800 cps, a “medium” viscosity may in the range from 400 to 800 cps, a low viscosity may be in the range from 50 to 400 cps, and an ultra-low viscosity may be in the range from 5 to 50 cps, for example. If a “high” viscosity alginate is desired, the citric acid pre-treatment may be carried out under ambient conditions for 60 minutes. If a “medium” viscosity alginate is desired, the citric acid pre-treatment may be carried out at higher temperature, i.e. 60° C. for 5 to 10 minutes, while if a “low” viscosity alginate is desired, the duration of the citric acid pre-treatment at 60° C. can be extended to 30 to 40 minutes. If an ultra-low viscosity alginate is desirable, i.e. one in which the alginate has been degraded to form oligosaccharides, an additional pre-treatment step may be carried out. Prior to citric acid pre-treatment, the alginate is treated with calcium ions to bind the G-blocks and protect them from degradation. This is then followed by citric acid treatment at 95° C. for at least 20 minutes.

The remainder of the process illustrated in FIG. 1 is common for each of the different target viscosities. In each case, the solids are rinsed with deionised water to remove excess citric acid, and the undissolved solids separated by filtration. Mineral acid (e.g. hydrochloric acid or sulphuric acid) is then added to the undissolved solids to adjust the pH to 1.7 to 1.9 thus displacing the calcium ions which are bound to the alginate in the macroalgae matrix. Mineral acid treatment is carried out for about 15 minutes. Thereafter, the resulting mixture is drained and the solid residue is rinsed with deionised water to remove excess mineral acid.

The mineral acid treated sample is then subjected to extraction using a saturated sodium carbonate solution. This solution is gradually added to the solid material and the pH held at 7 to 7.5 for 45 to 60 minutes whilst stirring. During this process, the alginic acid is neutralised by the sodium carbonate. This produces soluble sodium alginate, which can be extracted into solution for recovery. The solid and liquid components of the mixture are then separated. Optionally, the solid component can be used for cellulose production.

The liquid component is treated to recover sodium alginate in the form of a powder. Specifically, this is contacted with a mineral acid (e.g. hydrochloric or sulphuric acid) to reduce the pH to between 1.7 and 1.9. This converts the sodium alginate back to alginic acid, which is insoluble and precipitates as a thick alginic acid gel. This is recovered from solution by filtration. The gel is rinsed to remove excess acid, then converted to sodium alginate by the addition of a saturated sodium carbonate solution until the pH has reached 7.0. Addition of propan-2-ol precipitates the sodium alginate which is recovered as a solid by filtration. Drying at 30° C. under vacuum produces the desired sodium alginate product in the form of a white powder.

The method of the invention therefore provides a process in which the viscosity of the alginate can readily be adjusted by varying the precise conditions of the citric acid pre-treatment step. All downstream processing steps remain the same regardless of the initial citric acid treatment stage. This allows the same downstream processing equipment to be used which is advantageous in an industrial setting. Whilst the specific embodiment of the method shown in FIG. 1 is described in relation to Laminaria hyperborea and the use of citric acid, it will be appreciated that other macroalgae and other weak organic acids can be used in the method according to the invention, such as any of those described herein.

In one or more embodiments, the method of the invention provides an improvement over conventional industrial methods used in the production of alginate from macroalgae. Such improvements include, but are not limited to, the yield of alginate, the quality, purity and properties of the alginate produced by the method and the sustainability of the process. Advantageously, the method provides the ability to tune the properties of the extracted alginate material according to need, for example its molecular weight, its M/G ratio, etc.

As shown herein, the use of an organic acid is effective to degrade unwanted pigments in the macroalgae (e.g. polyphenols), including those present in the outer layer or “bark” of the stipe. It therefore aids in their removal thus providing a lighter coloured alginate product. In at least certain embodiments, the invention thus provides an alternative method for addressing the problem of unwanted colour in the extracted alginate. Significantly, it avoids the need for chemical or mechanical removal of the bark from the stipe prior to processing. This reduces the amount of wasted material and simplifies the manufacturing process when performed on an industrial scale. Further, it avoids the need to use known colour-fixing agents (e.g. formaldehyde and formaldehyde derivatives) and/or chemical bleaching agents such as hypochlorite to deal with the problem of colour. This produces an alginate material that requires no additional bleaching post-production and a residual cellulose-containing residue that is free from toxic chemicals such as formaldehyde.

In one set of embodiments, therefore, the method of the invention does not include any step of treating the macroalgae or part thereof with formaldehyde or a formaldehyde derivative.

In another set of embodiments, the method of the invention does not include any step of treating the macroalgae or part thereof with a bleaching agent. In a further set of embodiments, the method does not include the step of bleaching the recovered alginate material. In one set of embodiments, the method of the invention does not involve any bleaching step, i.e. the method does not involve the use of any bleaching agent. For example, the method does not involve the step of contacting any of the following materials with a bleaching agent: the macroalgae, or part thereof, any of the intermediate products produced during the method, and the recovered alginate. As used herein, the term “bleaching agent” refers to a chemical agent which is capable of lightening or whitening a substrate via a chemical reaction. Typically, a bleaching agent will be one involved in a bleaching reaction which involves an oxidative or reductive process that degrades a colour pigment. Examples of bleaching agents include, but are not limited to, any of the following: a compound comprising, or that acts as a source of, peroxide or peroxy acid, for example hydrogen peroxide, peroxide salt, peroxy acid, hydroperoxide, carbonate salt, percarbonate salt, 6-(phthalimido)peroxyhexanoic acid (PAP), peracetic acid; an oxidation catalyst, for example a mononuclear or dinuclear transition metal catalyst (for example manganese) (for example the oxidation catalyst may be selected from one or more groups selected from [(Mn^{IV})₂(u-O)₃(Me₃-TACN)₂]²⁺, [(Mn^{III})₂(u-O)(u-CH₃COO)₂(Me₃-TACN₂]²⁺ and [Mn^{III}Mn^{IV}(u-O)₂(u-CH₃COO)(Me₄-DTNE)]²⁺ and suitable salts thereof; a peroxide activator (i.e. a compound that reacts with a source of a peroxide group to provide a peroxide group), for example tetra acetyl ethylene diamine (TAED); a peroxy acid activator (i.e. a compound that reacts with a source of a peroxy acid to provide a peroxy acid group), for example tetra acetyl ethylene diamine (TAED); hypochlorite; a compound comprising, or that acts as a source of, chlorite; chlorine dioxide; chlorite salt; and chlorine. Typical bleaching agents include hydrogen peroxide, peroxyacids, persulfates, organic peroxides and hypochlorite.

Although the method herein described advantageously provides an alginate material that is light in appearance, it will be understood that the desired colour of the final alginate material will ultimately be dictated by its end application. For certain applications, it may be desirable to bleach the final alginate material. Where any bleaching agent is used, however, it may be used in low concentrations.

As demonstrated herein, the method of the invention unexpectedly provides an increase in yield of alginate. As used herein, the term “increased yield” refers to increased output of alginate from macroalgae processing. Whilst it might be assumed that the increase in yield could result from hydrolysis of the alginate chains by the organic acid (resulting in more of it being extracted), the evidence presented herein does not support this. Contrary to expectation, the viscosity of the alginate (which is indicative of its molecular weight) is not reduced at the expense of the increase in yield. Treatment with the organic acid thus not only allows for the recovery of higher alginate yields, but unexpectedly preserves the molecular weight (i.e. chain length) of the alginate resulting in higher viscosity when dissolved in water. Typical yields when performing the method of the invention may be in excess of 25%, preferably 30% or higher (on a dry weight basis). In some cases, the yield may be increased to above 40% (on a dry weight basis)

As a direct result of the method used in its preparation, the alginate material herein described differs from that produced using conventional industrial processes. In another aspect, the invention thus provides a novel alginate material, i.e. an alginate or alginate derivative obtainable, obtained or directly obtained by a method as herein described.

The colour of the obtained alginate is dependent on the nature of the starting material, i.e. the part or parts of the macroalgae that are used in its production. For example, the leaf is known to contain a higher proportion of pigments than the stipe and may produce a white to off-white product compared to that from stipe which may be “bone white”. However, the alginate product from leaf is sufficiently free from colour that it does not require additional bleaching to be useful as a product.

As demonstrated herein, irrespective of the selected input material the extracted alginate material produced according to the method of the invention is thus “light” in colour. The method of the invention enables the extraction of high quality, clean (i.e. decolourised) alginate material from any starting material, even from stipe that includes bark and epiphytes. In at least certain embodiments, the colour of the produced alginate material may be described as “off-white”, “white” or even “bone white”. Due to its reduced colour (i.e. reduced content of pigments), the alginate material is particularly suited to use in applications that require a low level of colour. The absence of toxic chemicals used in its production also makes it particularly suitable for pharmaceutical and food applications in which even trace amounts of chemicals conventionally used to address the problem of colour are not acceptable.

In certain embodiments, the alginate material will be substantially free from any pigments, such as polyphenols. For example, it may contain less than about 2% by weight, preferably less than about 1% by weight, e.g. less than about 0.5% by weight or less than about 0.3% by weight, of any pigments. In particular, it may contain less than about 2% by weight, preferably less than about 1% by weight, e.g. less than about 0.5% by weight or less than about 0.3% by weight, of any polyphenol. As will be understood, the conventional use of chemical bleaching agents to address the problem of colour does not necessarily remove the contaminants but may reduce their colour by converting these to other components having different light absorption and/or reflecting properties. A bleached alginate material, whilst not coloured, may thus still contain contaminants arising from the original pigments.

In certain aspects, the extracted alginate material will have a reduced content of any residual formaldehyde or any derivative of formaldehyde such as glutaraldehyde compared to that produced using conventional industrial processes. In one set of embodiments, the alginate material will thus be substantially free from formaldehyde or any derivative of formaldehyde such as glutaraldehyde. For example, it may have a residual content of formaldehyde or any derivative of formaldehyde which is less than about 2% by weight, preferably less than about 1% by weight, e.g. less than about 0.5% by weight or less than about 0.3% by weight. Most preferably, the content of formaldehyde or any derivative thereof will be below the limit of detection, i.e. it will be undetectable.

In certain aspects, the alginate material will have a reduced content of any residual chemical bleaching agent as herein described. In one set of embodiments, the alginate material will be substantially free from any chemical bleaching agent as herein defined, such as a hypochlorite bleach. For example, it may have a residual content of a chemical bleaching agent which is less than about 2% by weight, preferably less than about 1% by weight, e.g. less than about 0.5% by weight or less than about 0.3% by weight. Most preferably, the content of any chemical bleaching agent will be below the limit of detection, i.e. it will be undetectable.

The alginate produced according to the method of the invention may be further characterised in terms of molecular weight, polydispersity index, viscosity (i.e. the resultant viscosity of a solution in which it is dissolved), its M and G content, its M/G ratio, and its gelling properties (i.e. its ability to form a gel on contact with Ca²⁺ ions).

Unless otherwise specified, as used herein “molecular weight” refers to weight average molecular weight (Mw). Weight average molecular weight is the sum of the products of the molecular weight of any polymer fraction multiplied by its weight fraction. Molecular weight can be measured by Size Exclusion Chromatography with multi-angle static light scattering (SEC-MALS) using, for example, a mobile phase of Na₃PO₄+ EDTA for the samples. Calibration curves for determining molecular weights can be generated using pullulan molecular weight standards. SEC-MALS analysis can provide weight average molecular weight (Mw) and polydispersity index (PDI). Molecular weight (Mw) may, for example, be determined according to the procedure in the examples presented herein. Molecular weight of the alginate can be adjusted by varying the parameters of the organic acid pre-treatment as described herein. In this way, the molecular weight can be adjusted according to the desired use of the material. The molecular weight of the alginate may range from about 30 to about 650 kDa, for example from about 40 to about 500 kDa, or from about 50 to about 400 kDa, for example from about 60 to about 350 kDa. Due to the mild conditions employed in certain aspects of the method of the invention, the molecular weight of the alginate may be higher than that obtained by the current industry standard method. The molecular weight of the alginate may, for example, be at least 300 kDa. For example, it may be at least 310 kDa, preferably at least 320 kDa, more preferably at least 330 kDa, at least 340 kDa, at least 400 kDa, at least 450 kDa, at least 500 kDa, at least 550 kDa, or at least 600 kDa. As herein described, by adjusting the precise conditions employed in the organic acid pre-treatment step, for example when using higher treatment temperatures and/or longer treatment times, alginate having a lower molecular weight may be obtained as desired.

As referred to herein, the polydispersity index (PDI) of a polymer is calculated by dividing the weight average molecular weight of the polymer by its number average molecular weight. The number average molecular weight can be measured using SEC-MALS, for example as herein described. The closer to 1.0 the polydispersity index, the more uniform the molecular weight range of the polymer. The polydispersity index of the alginate may range from 1.2 to 3.5, for example from 1.2 to 2.7, from 1.2 to 2.6, from 1.2 to 2.3, or from 1.2 to 2.0, for example from 1.3 to 1.9. In a preferred embodiment, the polydispersity index is low, for example in the range from 1.2 to 2.0, for example from 1.2 to 1.8, for example from 1.2 to 1.5, e.g.

about 1.4. The ability to produce alginate having a low PDI is advantageous since its uniformity allows greater flexibility in any downstream methods which might be used to further adjust its Mw according to the desired end use.

The α-L-guluronate (G) content of the alginate can be determined using methods known in the art, such as 1H-NMR. For example, it may be determined using the method of Grasdalen et al. described in the examples. The α-L-guluronate (G) content of the alginate obtained by the method described herein may range from about 55 to 80%, for example from about 60 to 80%, or from 65 to 75%. In certain embodiments, the α-L-guluronate (G) content is greater than 70%, e.g. greater than 75%.

The invention is also directed to products that contain the alginate and alginate materials herein described. Examples of such products include food products, pharmaceuticals, agrochemical products, healthcare products, biomedical products, cosmetic products, textile products, paper and cardboard products, etc.

The invention will be described in more detail by way of the following non-limiting examples and the accompanying figure in which:

FIG. 1 is a schematic showing methods in accordance with embodiments of the invention.

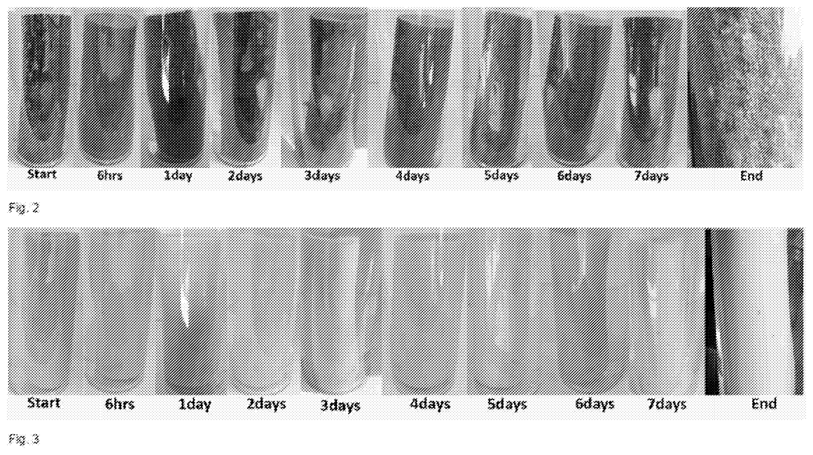

FIG. 2 shows images of whole stipe treated in 1% (w/v) citric acid.

FIG. 3 shows images of peeled stipe treated in 1% (w/v) citric acid.

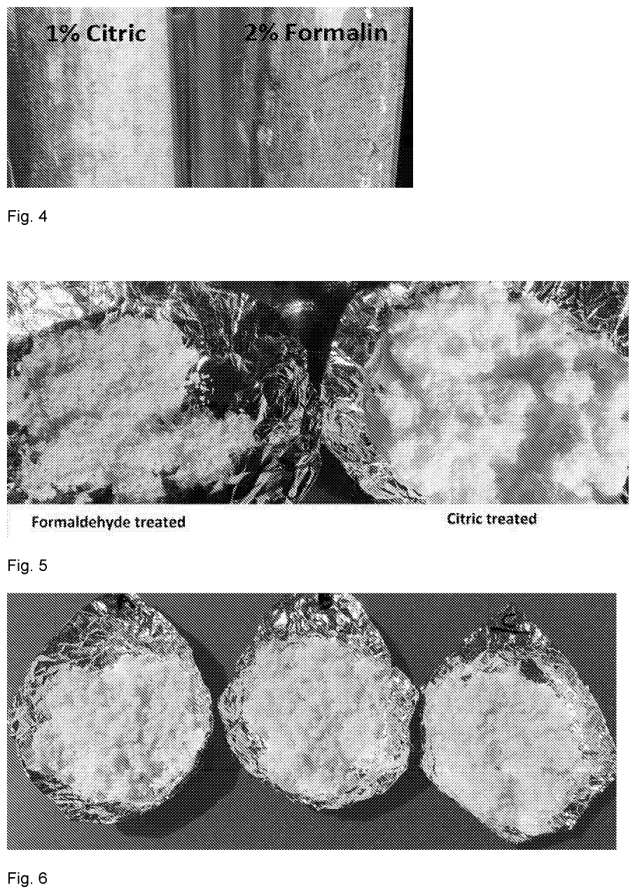

FIG. 4 shows images comparing whole stipe treated in 1% (w/v) citric acid and 2% formaldehyde solution.

FIG. 5 shows images of alginate samples produced following a citric acid pre-treatment in accordance with the invention and following treatment with formaldehyde.

FIG. 6 shows images of alginate samples produced following a citric acid pre-treatment in accordance with the invention.

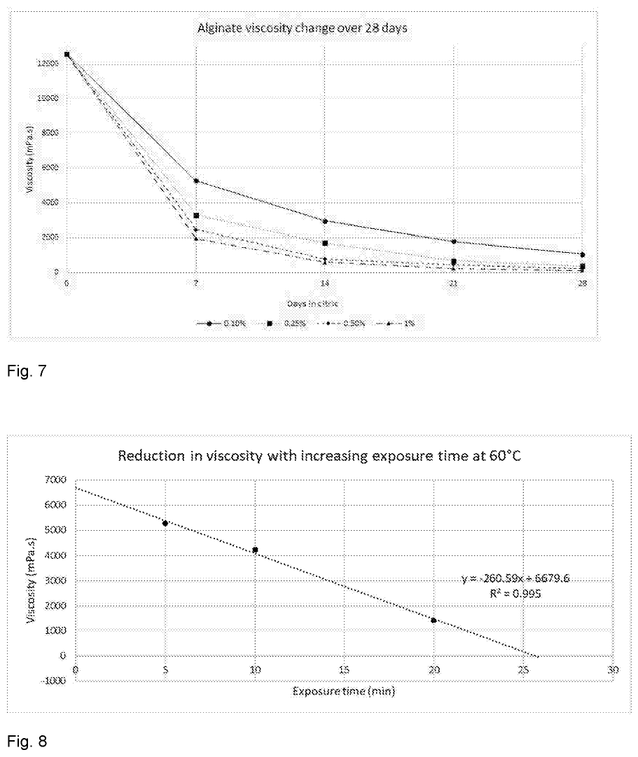

FIG. 7 shows the effect of duration of citric acid exposure on alginate solution viscosity using citric acid solutions having concentrations of 0.10%, 0.25%, 0.50% and 1.00% (w/v).

FIG. 8 shows the effect of increasing exposure time of citric acid at 60° C. on alginate solution viscosity.

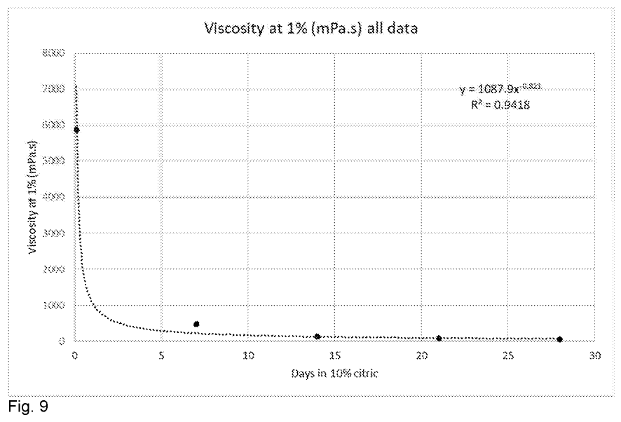

FIG. 9 shows the effect of duration of citric acid exposure on alginate solution viscosity using a citric acid solution having a concentration of 10% (w/v).

### EXAMPLES

General Procedure:

Preparation of starting material:

Preparation of dried, flaked L. hyperborea: the leaf and epiphytes were removed, but the bark was left on prior to shredding and drying to produce a stable intermediate (dried stipe). This was re-hydrated by the addition of water prior to carrying out the pre-treatment process. Re-hydration by water washing and removal of residual water served to extract salt and other unwanted water-soluble components, including polyphenols, from the stipe matrix.

Preparation of freshly shredded L. hyperborea stipe: the leaf and epiphytes were removed and the stipe with bark was soaked in demineralised water to remove salt so that the solution conductivity was less than 200 μS. The soaked stipe was then blended using a Tefal Blendforce II, type BL42 blender with a 600W motor on the highest power setting.

For both dried and fresh materials, the particle size of the stipe was in the range of approximately 500 to 1000 μm.

Organic acid pre-treatment:

Re-hydrated stipe as prepared above was added to a blender. A 1% w/v solution of the chosen organic acid in demineralised water was prepared, and sufficient organic acid solution added to the reaction vessel to cover the re-hydrated stipe in the blender. The resulting reaction mixture was then blended using 2×5 second blending pulses or a single 10 second blending pulse. After blending, the resulting mixture was transferred to a container. A further aliquot of 1% w/v of the organic acid solution was used to rinse the blender, and the rinse solution was also transferred to the container. The contents of the container were then left to soak for 60 minutes with stirring.

Metal cation exchange:

The liquid was separated from the undissolved solids by filtration or centrifugation. The filtrate or the liquid phase from the centrifuge, which contains the organic acid solution, was collected. The sample in the filter or centrifuge was then rinsed with demineralised water to remove excess organic acid, and the sample was returned to the container and further water added to rinse. The liquid was again separated from the undissolved solids by filtration. The sample was then transferred to a blender and hydrochloric acid added to the reaction mixture to reduce the overall pH to between 1.7 and 1.9. The acidified sample was then blended using 2×5 second blending pulses or a single 10 second blending pulse, and the sample left to stand with or without stirring. The sample was then drained through a filter or transferred to a centrifuge, and the obtained solid fraction was transferred to a container and rinsed with demineralised water to remove excess hydrochloric acid. The filtrate or the liquid phase from the centrifuge, which is a hydrochloric acid solution, was collected.

Extraction of alginate;

The mineral acid treated sample was then drained through a filter or separated using a centrifuge and the solids transferred to a blender. Saturated sodium carbonate solution was added to the blender, and the resultant mixture blended using 2×5 second blending pulses or a single 10 second blending pulse. The pH of the blended mixture was approximately 9, but rapidly decreases as the carbonate reacts with the alginic acid. The blended mixture was then transferred to a reaction vessel and further saturated sodium carbonate solution was added with stirring over a period of 30 to 45 mins to maintain a solution pH of approximately 7.0 to 7.2. During this process, the alginic acid is neutralised by the sodium carbonate. This produces soluble sodium alginate, which can be extracted into solution for recovery.

After stirring for 30 to 45 mins, the solid particles were removed from the solution by filtration or centrifugation to obtain a primary extract. Once all of the liquid had been collected, the solids on the filter were transferred to a beaker and mixed with demineralised water. This mixture was left to stand or mixed for 10 mins, during which time most of the remaining alginate was extracted, and then filtered to obtain a secondary extract. The primary and secondary extracts were then combined to form an alginate solution.

Alginate recovery (“alginic acid route”):

Hydrochloric acid was added to the alginate solution with mixing to reduce the pH to between 1.7 and 1.9. This converts the sodium alginate to alginic acid, which is insoluble and precipitates as a thick transparent gel. The solution was then filtered, and the gel was retained on the filter, or the solution was transferred to a centrifuge and the gel collected. To convert the gel to sodium alginate, it was transferred to a reaction vessel and a saturated sodium carbonate solution was gradually added with stirring until the pH was between 7.0 and 7.3.

An equal volume (1:1 ratio) of propan-2-ol was added to the solution of sodium alginate. The solution was then mixed, which caused sodium alginate to be displaced from the solution as a thick gel. The resulting mixture was then transferred to a blender and pulsed for 5 seconds to disperse the gel and complete the precipitation process. The mixture was then filtered or transferred to a centrifuge to recover the product, and the propan-2-ol recovered using a rotary evaporator.

To remove the remaining water from the gel-like product obtained, the sample was returned to the blender and a further portion of propan-2-ol was added. The resulting mixture was blended for 5 seconds, and then filtered or transferred to a centrifuge. The sodium alginate was obtained as a pellet on the filter or in the centrifuge, and the propan-2-ol was recovered. The pellet of alginate was then dried at 30° C. in a vacuum oven. The evaporated propan-2-ol was directly condensed and recovered.

### Example 1—Organic Acid Pre-treatment

Dried stipe of L. hyperborea was re-hydrated, subjected to organic acid pre-treatment and subsequent extraction to produce alginate as described in the general procedure above. The following readily available food grade acids were tested in the pre-treatment step: ascorbic acid, lactic acid, citric acid, malic acid and acetic acid.

Alginate yield was determined. Viscosity of a 1 wt. % solution of the obtained alginate was measured using the falling ball viscometer method. The results are presented in Table 1 below, along with molecular weight and pKa values for the tested organic acids. For comparison purposes, the pKa of alginic acid (“alginate”) is in the range from 1.5-3.5 and that of hydrochloric acid is −5.9.

TABLE 1

| | | | | Molecular | pKa |
|---|---|---|---|---|---|
| | Alginate | Alginate | E | weight of | range of |
| Organic Acid | Yield | Viscosity | num- | organic | organic |
| Pre-treatment | (%) | (mPa · s) | ber | acid | acid |
| No organic acid | 24 | 170 | | | |
| Ascorbic acid | 31.5 | 400 | E300 | 176.2 | 4.2-11.6 |
| Lactic acid | 31.5 | 300 | E270 | 90.08 | 3.8-15.1 |
| Citric acid | 37.5 | 1300 | E330 | 192.12 | 3.13-6.39 |
| Malic acid | 34.0 | 850 | E296 | 134.09 | 3.4-5.2 |
| Acetic acid | 32.5 | 200 | E260 | 60.05 | 4.76 |

Pre-treatment using each of the organic acids resulted in an increase in yield and viscosity of solutions of the produced alginate. High viscosity is an indication that the alginate is not degraded to an appreciable extent in the alginate extraction process. Citric and malic acids were most effective in terms of the highest yield and viscosity of the produced alginate. Though not wishing to be bound by theory, it is possible that the reason for citric and malic acids being more effective than the other organic acids arises from their primary pKa values, both of which are close to the upper limit for alginic acid (pKa 3.5). This may allow for selective alginate chain cleavage without significant degradation as seen with high strength acid or alkali treatment.

The alginate obtained without organic acid pre-treatment was light brown in colour, whereas all alginate samples produced following pre-treatment with the organic acids were white in colour.

### Example 2—Citric Acid Treatment vs. Formaldehyde Treatment

Whole (i.e. unpeeled) stipe and peeled stipe were treated in 1% (w/v) citric acid solution for 7 days and the colour observed. By way of comparison, whole stipe samples were also treated with 2% formaldehyde as per the current industry standard.

Citric acid removed the brown pigmentation from the whole stipe (including the bark), leaving behind traces of chlorophyll which are green. The images in FIG. 2 show the colour reduction for whole stipe treated with citric acid solution. As can be seen in the images, as time progresses the original brown pigmentation of the stipe is degraded and the green colour of the remaining chlorophyll residue can be seen. Similar results were observed when treating a blended stipe sample with 1% (w/v) citric acid vs. simply soaking in water.

When the bark had been removed, the stipe still had a faint brown colour but once treated with 1% (w/v) citric acid the colour was seen to rapidly fade and the stipe whitened. The images in FIG. 3 show the colour reduction for peeled stipe treated with citric acid solution.

When testing whole stipe, the colour changes are slow due to the density of the stipe structure, but when the size of the stipe is reduced (e.g. by chopping, milling, etc.) the change in colour is rapid.

By comparison, the samples treated with 2% formaldehyde had a very different response. These darkened with time and became much browner. This is believed to be the result of polymerisation of the phenolic species present which, in their non-polymerised form, do not possess colour. The images in FIG. 4 show the stipe treated with 1% (w/v) citric acid and a 2% formaldehyde solution after 7 days.

Alginate was extracted from the stipe samples treated with citric acid and formaldehyde using the extraction method described in the general procedure above. Images of the produced alginate are shown in FIG. 5. The formaldehyde treated sample produced a brown alginate material which would require bleaching to achieve the same colour as that produced from the stipe pre-treated with citric acid. In contrast to the current industrial process, the citric acid pre-treatment method according to the invention produces clean, substantially colour-free alginate without the use of formaldehyde.

### Example 3—Citric Acid Pre-treatment

Dried stipe of L. hyperborea was re-hydrated, subjected to citric acid pre-treatment and subsequent extraction to produce alginate material as described in the general procedure above.

Stipe powder was re-hydrated using demineralised water. This also served to remove unwanted soluble components, such as polyphenols, which were extracted into the water. The dark orange colour of the wash water at this stage is indicative of the presence of oxidised polyphenols. As the molecular weight of the polyphenols has not been significantly affected, they remain water-soluble and a high proportion of the polyphenols is removed. Subsequent treatment with a citric acid solution at room temperature (1% w/v for 60 minutes) extracts the remainder of the free polyphenols and breaks down the carotenoids and chlorophyll residues, which are then washed out when the acid solution is drained off. This further reduces the levels of colour-contributing materials present in the starting matrix whilst reducing the molecular weight of the native alginate which improves solubilisation and extraction efficiency. The citric acid treated material is further rinsed to remove remaining contaminants before passing to the remainder of the extraction process.

Standard industrial processes use formaldehyde to treat the macroalgae after harvesting in order to prevent microbial degradation of the macroalgae and to sequester polyphenols through polymerisation. The formaldehyde forms complexes with the polyphenols thereby increasing their molecular weight and rendering them insoluble and unable to impart colour to the alginate. In contrast to the method according to the invention in which polyphenols are removed prior to alginate extraction, the polymerised polyphenols produced as a result of formaldehyde treatment are carried forward to the extraction phase.

Method:

Re-hydrated stipe powder was added to a blender with 250 ml of 1% w/v citric acid (anhydrous) and blended for 2×5 seconds. The blended sample was transferred to a container and held for 60 minutes at room temperature with stirring. The colour of the particles lightened as coloured compounds were destroyed or removed.

After 60 minutes, the mixture was drained through a 160 mesh nylon bowl filter (approx. 100 μm) to retain solids. The solids were then transferred to a blender with 300 ml demineralised water and 10 ml of 10% HCl and blended for 2×5 seconds with a resulting pH of 1.7 to 1.9.

The mixture was then transferred to another container and held for 15 minutes with stirring. After 15 minutes, the mixture was drained though a 160-mesh filter and pressed to remove as much liquid as possible. The solids were then transferred to a jug with 300 ml water to remove excess residual acid. After 15 minutes, the mixture was drained though a 160-mesh filter and pressed to remove as much liquid as possible, and then the solids were transferred to a blender with 500 ml of 0.25% w/v sodium carbonate solution and blended for 2×5 seconds. The resulting mixture was transferred to a container, and rinsed with a further 0.25% w/v sodium carbonate solution. The volume was then made up to 700 ml. The pH was checked and adjusted to between 8 and 8.5 with saturated sodium carbonate solution if needed, and then the solution was held for 30 minutes with stirring. The solution was transferred to a blender and blended for 2×5 seconds, and then held for a further 30 minutes. After a total extraction time of 60 minutes, the highly viscous solution was filtered through a 160-mesh nylon filter and the solids were retained. The solids were then re-extracted in a further 400 ml of water, and the pH adjusted to between 8 and 8.5 by the addition of saturated sodium carbonate solution and held for 15 minutes. The solids were then filtered through a 160-mesh nylon filter and all liquid was collected.

The resulting extract was then acidified to between pH 1.7 and 1.9 with hydrochloric acid under gentle stirring so as not to dissociate the alginic acid gel. Gel formation was allowed for 10 minutes before the gel was filtered through 200-mesh nylon filter to collect the alginic acid gel. Excess water was allowed to drain from the gel before the gel was transferred to a beaker. The pH of the gel was then adjusted to between 7.1 and 7.4 using saturated sodium carbonate solution to ensure complete deprotonation by replacing the protons in the alginic acid with sodium ions. The buffered gel was then added to the blender with an equal volume of methanol, ethanol or propan-2-ol (depending on availability), and blended. This dissociated and dehydrated the gel, which was then filtered and squeezed for drying. The filtered, squeezed sodium alginate was then transferred to a coffee grinder and pulsed gently to break up the fibrous mass, before being transferred to a drying dish and dried in the oven at 95° C. for 30 to 60 minutes (dependant on sample size).

The experiment was carried out in triplicate (Tests A, B and C), and the results are shown in Table 2 below:

TABLE 2

| | | | | Alginate |
|---|---|---|---|---|
| | Sample | Dry mass | Alginate | Yield |
| | (g) | (g) | (g) | (% of dry) |
| Test A | 50.93 | 2.67 | 1.086 | 40.6 |
| Test B | 48.075 | 2.53 | 1.038 | 41.1 |
| Test C | 51.305 | 2.81 | 1.145 | 40.8 |

The alginate obtained was white in colour, despite the lack of any bleaching agents in the process. This was also achieved using a fully ambient process with no thermal input. Furthermore, the process time was less than 4 hours from hydration of the stipe powder, and the high viscosity of the extract solution indicates that a high molecular weight alginate is obtained.

### Example 4—Analysis of Molecular Weight and α-L-guluronate (G) Content of Alginate Produced Using Citric Acid Pre-treatment

A sample of alginate was obtained from 8 separate laboratory extractions using the general procedure described above. The alginate recovered was a “bone white” fibrous solid (see FIG. 4). The average yield over the 8 extractions was 36.8% (based on input dry matter content) and the alginate (1% solution) had an average viscosity of 6200 mPa·s (measured using falling ball method).

Molecular weight of the alginate samples was determined by size-exclusion chromatography (SEC-MALS), i.e. high performance liquid chromatography (HPLC) equipped with online multi-angle static light scattering (MALS). The separations were performed using 1+3 columns by Shodex, implemented in the following order: OHpak LB-G, LB-806, LB-805 and LB-804. The temperature of the columns was adjusted to 40° C. using the Agilent 1260 Infinity II Multicolumn Thermostat, while the measurements were performed at 25° C. Measurements were executed through a Dawn HELEOS-8+ multi-angle laser light scattering photometer (Wyatt, Santa Barbara, CA, USA) (λ₀=660 nm) and a subsequent Optilab T-rEX differential refractometer. A mobile phase of 0.10 mol/L Na₃PO₄ (pH=7)+0.01 mol/L EDTA was used. The flow rate was 0.5 mL/min. The injection volumes were 50 μL, with an alginate concentration of 3 g/L. Pullulan standard (GPC 50,000) by Sigma Aldrich was used for the instrument normalization. The data were obtained and processed using Astra (v. 7) software (Wyatt, Santa Barbara, CA, USA). From the obtained measurements of Mw (mass-weighted molecular weight) and Mn (number-weighted molecular weight), the polydispersity (Mw/Mn) of the sample was calculated.

The α-L-guluronate (G) content was determined by 1H-NMR. 1H-NMR analysis was performed using a Bruker BioSpin 500WB at 500 MHz and 368 K (95.035° C.). The solvent was D₂O, and the alginate concentration was 30 g/L. The M/G ratio, and thereby the G content, was determined using the method described in Grasdalen et al., 13C NMR Studies of Monomeric Composition and Sequence in Alginate, Carbohydr. Res., 1981, 89, 179-191 and Grasdalen, High-field, 1H-NMR spectroscopy of alginate: sequential structure and linkage conformations, Carbohydr. Res., 1983, 118, 255-260.

The alginate produced by the citric acid method was found to have a molecular weight of 348.6 kDa and an α-L-guluronate (G) content of 67%. Typical parameters for L. hyperborea derived alginate are around 300 kDa with a “G” content between 65 to 70%. The molecular weight is higher than expected. The alginate had a polydispersity of 1.42 which indicates that a narrow molecular weight fraction has been extracted. This is in contrast to standard methods of alginate production which provide materials having a wider distribution of molecular weights.

### Example 5—Effect of Extended Exposure to Citric Acid

Re-hydrated L. hyperborea stipe material was exposed to 0.10, 0.25, 0.50 and 1.00 (% w/v) solutions of citric acid for 7, 14, 21 and 28 days under ambient conditions. Alginate was subsequently extracted using the method described in the general procedure above and its viscosity was measured using the falling ball method.

As can be seen from FIG. 7, the viscosity of the extracted alginate is reduced as a function of time when the stipe is exposed to citric acid. The higher the concentration of citric acid used in the pre-treatment, the lower the viscosity of the alginate. Even though the resulting solutions were of low viscosity, they were all capable of producing stable, coherent gels when exposed to Ca²⁺ ions (calcium chloride solution). This demonstrates that there is a predominance of α-L-guluronate (G-blocks) present which can cross-link in the presence of Ca²⁺ ions.

The results demonstrate that exposure to concentrations as low as 0.1% (w/v) over an extended period can reduce the viscosity (intrinsically linked to molecular weight) of the alginate that is subsequently extracted. Molecular weight of the alginate can therefore be adjusted according to need by varying the concentration of the citric acid and the duration of the treatment.

### Example 6—Use of Citric Acid at Elevated Temperatures

Re-hydrated L. hyperborea stipe material was exposed to a 1% (w/v) citric acid solution at 60° C. over a period of 5 to 20 minutes. Alginate was extracted and recovered as described in the general procedure above, and the viscosity of the resulting 1% alginate solutions was measured.

The results in FIG. 8 show a predictable rate of decrease in viscosity with increasing exposure time. From the measured viscosities a rate of decrease in viscosity with time can be calculated according to the following equation:

$$\frac{( Start viscosìty - End viscosity )}{( End minutes - Start minutes )} = \frac{Cha𝔫ge in viscosity ( mPa \cdot s )}{Total minutes} = {Δ}_{Visc ( mPa \cdot s / min )}$$

Start viscosity at 5 min=5270 mPa·s

End viscosity at 20 min=1414 mPa·s

Viscosity difference (5270-1414)=3855 mPa·s

Time difference=(20-5)=15 minutes

Δ visc=(3855/15)=257 mPa·s min⁻¹

This relationship can be used to adjust the time of exposure to the organic acid to tailor the viscosity (and hence molecular weight) of the alginate as desired.

Increasing the temperature of the citric acid solution to 95° C. produced a much higher rate of viscosity reduction. It was calculated that this gave Δ visc=598 mPa·s min⁻¹.

### Example 7—Treatment with Calcium Ions

As calcium ions are known to cross-link G-blocks in alginate complexes it was speculated that pre-saturating the alginate in the stipe matrix may inhibit G-block degradation. To test this hypothesis, two samples were obtained from a single re-hydrated batch of stipe material. One of the samples was pre-treated with 5% calcium chloride solution prior to citric acid pre-treatment and extraction of alginate, while the other was only pre-treated with citric acid prior to alginate extraction. Citric acid pre-treatment was performed using 1% (w/v) citric acid at 95° C. for 10 minutes.

It was found that the alginate yield in the sample treated with calcium ions was approximately 10% higher than the untreated one (45.7 vs 36.0%), which indicates that alginate is being protected from degradation by the calcium ions. It was also found that both samples produced alginate which had the same resultant viscosity of 19 mPa·s, and which produced gels when exposed to calcium ions.

Samples of the alginate obtained from each experiment were subjected to analysis as described in Example 4 using size exclusion chromatography to find the molecular weight and 1H-NMR to ascertain the “G” content. The results are shown in Table 3.

TABLE 3

| | Alginate | Molecular | Poly- | α-L- |
|---|---|---|---|---|
| | yield | weight | dispersity | guluronate |
| Sample | (%) | (kDa) | (Mw/Mn) | (G) content |
| Standard citric acid | 36.8 | 348.6 | 1.42 | 67 |
| treatment | | | | |
| (as described in | | | | |
| Example 2) | | | | |
| Treated with calcium | 45.7 | 81.64 | 1.89 | 72 |
| ions, then citric acid at | | | | |
| 95° C. for 10 mins | | | | |
| Treated with citric acid | 36.0 | 75.68 | 1.84 | 76 |
| at 95° C. for 10 mins | | | | |
| (no calcium treatment) | | | | |

The addition of calcium ions as a pre-treatment protects alginate from degradation because it results in a higher yield. However, in so doing more “M-blocks” are present, which results in a lower overall “G” content when compared to the untreated sample (72 vs. 76% “G”).

The use of citric acid at elevated temperatures has been shown to reduce alginate molecular weight and increase the α-L-guluronate (G) content in the resulting oligomers via the degradation of β-D-mannuronate (M). These conditions could be further applied (longer duration or higher temperature) to enhance the reduction of the molecular weight of the oligomers and result in further increases in α-L-guluronate (G) content. They can be further used to enhance the α-L-guluronate (G) content of extracted leaf alginate, which is normally about 50/50 or about 45/55 (G/M), to that which approximates stipe alginate, which is typically about 70/30 (G/M).

### Example 8—Comparison of Organic Acid Pre-treatments

To evaluate the efficacy of the organic acid pre-treatment, experiments were conducted using the general procedure as outlined above, but with differing pre-treatments and with different parts of seaweed. Specifically, the pre-treatments were as follows:
1) demineralised water
2) 1% citric acid
3) propan-2-ol and
4) 2% formaldehyde.

The seaweed samples were as follows: (a) stipe+bark+epiphytes (i.e. “unpeeled stipe” with epiphytes); (b) stipe+bark (i.e. “unpeeled stipe” without epiphytes); and (c) peeled stipe. “Unpeeled stipe” refers to stipe with the bark, “peeled stipe” refers to stipe from which the bark has been removed. The seaweed samples were vacuum packed and chilled for transport.
(a) Extraction of alginate from stipe+bark+epiphytes

The results for the different pre-treatments are shown in Table 4 below:

TABLE 4

| | | Dry | | Alginate | |
|---|---|---|---|---|---|
| | Sample | mass | Alginate | Yield | Viscosity |
| | (g) | (g) | (g) | (% of dry) | (mPa · s) |
| Demineralised water | 51.75 | 3.17 | 0.632 | 19.9 | 16370 |
| 1% citric acid | 51.19 | 3.14 | 0.707 | 22.5 | 90422 |
| Propan-2-ol | 52.35 | 3.21 | 0.453 | 14.1 | 30134 |
| 2% formaldehyde | 49.89 | 3.06 | 0.523 | 17.1 | 70836 |

As can be seen from Table 4, alginate obtained from the sample which was subjected to the citric acid pre-treatment was obtained in a substantially higher yield and with a higher viscosity than samples obtained using other, industry standard pre-treatments. It was also observed that pre-treatment with citric acid provided a lighter alginate than pre-treatment using formaldehyde, which is typically used to reduce the colour of the extracted alginate.
(b) Extraction of alginate from stipe+bark

TABLE 5

| | | Dry | | Alginate | |
|---|---|---|---|---|---|
| | Sample | mass | Alginate | Yield | Viscosity |
| | (g) | (g) | (g) | (% of dry) | (mPa · s) |
| Demineralised | 52.442 | 2.28 | 0.543 | 23.8 | 40817 |
| water | | | | | |
| 1% citric acid | 51.318 | 2.23 | 0.698 | 31.3 | 91954 |
| Propan-2-ol | 50.936 | 2.21 | 0.399 | 18.0 | 45708 |
| 2% formaldehyde | 51.742 | 2.25 | 0.578 | 25.7 | 45434 |

A similar trend was observed for samples in which the epiphytes had been removed, though the yield and viscosity of alginate extracted using citric acid was even higher. The sample treated with 2% formaldehyde provided alginate material that was relatively dark in colour (this was especially noticeable when the material was dissolved for the viscosity test), whereas the remaining samples provided alginate material that was uncoloured or light in colour.
(c) Extraction of alginate from peeled stipes

TABLE 6

| | | | | Alginate | |
|---|---|---|---|---|---|
| | Sample | Dry mass | Alginate | Yield | Viscosity |
| | (g) | (g) | (g) | (% of dry) | (mPa · s) |
| Demineralised | 52.279 | 2.60 | 0.517 | 19.8 | 32001 |
| water | | | | | |
| 1% citric acid | 51.114 | 2.55 | 0.909 | 35.7 | 44679 |
| Propan-2-ol | 51.527 | 2.57 | 0.571 | 22.2 | 37964 |
| 2% | 53.144 | 2.65 | 0.519 | 19.6 | 35178 |
| formaldehyde | | | | | |

All of the samples produced alginate material that was uncoloured or light in colour.

Conclusion:

The alginate recovered using citric acid pre-treatment had a consistently higher yield and viscosity compared to the other pre-treatment methods. The viscosity from the peeled stipe citric acid sample was significantly lower than that from the samples where the bark was still present. This suggests that the oldest alginate (and hence that containing the highest proportion of “G” blocks) is in immediate proximity to the bark layer and is possibly lost when the stipe is peeled.

These experiments demonstrate that the citric acid pre-treatment allows the extraction of excellent quality alginate from both peeled and unpeeled stipe portions, giving a clean product in all cases. It was also observed that the alginate with the strongest colour in each case was derived from material that had been pre-treated with 2% formaldehyde.

### Example 9—Extraction of Alginate from Leaf Powder

Leaf powder was pre-treated with 50% propan-2-ol. It was not hydrated with water to avoid the release of fucoidan, which makes the material difficult to handle because of the resultant viscosity. Alginate was extracted from the leaf powder samples as follows:

A—pre-treatment with 50% propan-2-ol; extraction with mineral acid only

B—pre-treatment with 50% propan-2-ol containing 1% citric acid; extraction with mineral acid

C—pre-treatment with 50% propan-2-ol containing 1% malic acid; extraction with mineral acid

Each sample was washed with 50% propan-2-ol (3×200 ml) and acid, where required, before filtering and treatment with 100% propan-2-ol as a final wash. This final wash resulted in the removal of all green colouration, leaving the remaining solid pale brown. Each sample was then extracted by treatment with hydrochloric acid at pH 1.8 for 15 mins, followed by extraction with 0.25% sodium carbonate (700 ml, pH 8 to 8.5). The resulting product was dried at 30° C. overnight, and the yield recorded. The results are provided in Table 7:

TABLE 7

| | Alginate | Viscosity |
|---|---|---|
| | (% of dry) | (mPa · s) |
| A - Propan-2-ol only | 4.5 | 713 |
| B - Propan-2-ol and 1% citric acid | 21.9 | 17247 |
| C - Propan-2-ol and 1% malic acid | 24.5 | 13012 |

Pre-treatment using citric acid and malic acid provided a far higher yield of alginate, and the alginate obtained had a much higher viscosity than when propan-2-ol was used alone.

The resulting leaf alginate was white to off-white and does not require additional bleaching to be useful as a product. In contrast, leaf alginate produced using formaldehyde is typically dark brown and requires significant bleaching before it can be used.

### Example 10—Sodium Citrate Pre-treatment

Two samples of stipe powder were re-hydrated as described above. Each sample was then treated for 60 minutes with a solution containing 1 wt. % sodium citrate and 1 wt. % citric acid. After pre-treatment, the samples were drained and rinsed, then treated with hydrochloric acid at pH 1.8 for 5 minutes. The samples were then drained and rinsed to remove excess acid before being extracted with water (700 ml) which was buffered to pH 7.5 with saturated sodium carbonate. The samples were then dried overnight, and the yield of alginate and viscosity were recorded. The results are provided in Table 8:

TABLE 8

| | Alginate (% of dry) | Viscosity (mPa · s) |
|---|---|---|
| Sample A | 33.76 | 35738 |
| Sample B | 30.86 | 36977 |

### Example 11—Calculation of CO₂ Emissions Compared to the Current Industry Standard Process

Most of the CO₂ emissions in the alginate process result directly from the use of sodium carbonate (Na₂CO₃), the CO₂ being released whenever it encounters an acid. For example, when using either sulphuric or hydrochloric acid to neutralise the sodium carbonate, the direct emissions arise from the following reactions:

Na₂CO₃+H₂SO₄ [symbol] Na₂SO₄+CO₂+H₂O

Na₂CO₃+2HCL [symbol] 2NaCl+CO₂+H₂O

The stoichiometric balance is the same in both reactions and therefore the amount of CO₂ produced by either acid is the same. Irrespective of the acid used in the reaction, every 1 kg of unreacted sodium carbonate produces 0.415 kg of CO₂ when neutralised.

When stipe material is reacted with a mineral acid, the metal cations which are present in the alginate are exchanged with protons resulting in the formation of alginic acid (“Alginate-H⁺”). In the subsequent extraction phase this reacts with the sodium carbonate producing soluble sodium alginate. This proceeds in accordance with the following reaction:

2Alginate-H⁺+Na₂CO₃ [symbol] 2Alginate-Na+CO₂+H₂O

Molecular mass cannot be used directly to calculate the stoichiometric balance, but the reaction can be simplified to H⁺ and CO₃²⁻. For every 1 kg of CO₃²⁻ that reacts directly with alginic acid, it produces 0.365 kg of CO₂. When the process according to the invention operates at neutral pH, no additional dissolved solids are present as the “salt” is sodium alginate and there is no excess sodium carbonate present. However, this is not the case for the current industrial method used to produce alginate in which a large excess of sodium carbonate is present in the extract solution.

On a process basis (assuming no excess process chemicals) the emission of CO₂ for a process in accordance with the invention is shown in Table 9 below, calculated per 1000 kg of starting stipe material that has had the salt removed.

TABLE 9

| | Alginate | Na₂CO₃ | CO₂ total |
|---|---|---|---|
| | (kg) | (kg) | (kg) |
| Stipe (1000 kg) | 400 | 285.700 | 118.6 |
| 1000 kg alginate | 1000 | 714.250 | 296.6 |

From this it can be seen that processing 1000 kg of salt-depleted stipe results in emission of 118.6 kg of CO₂ which translates to 296.6 kg of CO₂ per tonne of alginate produced.

In certain aspects of the invention, a concentration of sodium carbonate in the extraction solution of between 0.2 and 0.25% may be used (depending on residual levels of mineral acid present after rinsing). When comparing a concentration of 0.25% to the industry standard which uses a minimum of 4% sodium carbonate, for every 1000 L of extraction solution, the following can be calculated:

TABLE 10

| | Na₂CO₃ | CO₂ per 1000 L | |
|---|---|---|---|
| | concentration | of Na₂CO₃ solution | CO₂ total |
| | (%) | (kg) | (kg) |
| Industry standard | 4 | 40 | 16.6 |
| Invention | 0.25 | 2.5 | 1.0 |

This shows that the industry standard method will produce 16.6 times more CO₂ than the method of the invention.

Furthermore, the use of sodium hydroxide as a replacement for sodium carbonate offers a zero CO₂ emission profile for this part of the process.

### Example 12—Effect of Extended Exposure to Citric Acid—10% w/v Solution

The experiments described in Example 5 were repeated using a 10% w/v solution of citric acid. The results are presented in FIG. 9. As observed for the lower citric acid concentrations used in Example 5, the viscosity of the extracted alginate is reduced as a function of the duration of exposure of the stipe to the citric acid. However, the reduction in viscosity is more rapid when the stipe is treated with the higher 10.00% w/v solution of citric acid than with the lower concentrations.

Although the resulting alginate solutions were of low viscosity, they were all capable of producing stable, coherent gels when exposed to Ca²⁺ ions (calcium chloride solution). This confirms the predominance of G-blocks in the extracted alginate.

The results demonstrate that a more rapid, yet still predictable, reduction in the viscosity (and thus molecular weight) of the alginate can be obtained by increasing the concentration of citric acid employed in the pre-treatment step.

### Example 13—Comparison of Citric Acid+Mineral Acid Pre-treatment According to the Invention vs. Citric Acid or Mineral Acid Alone

Experiments were performed to compare the effect of the pre-treatment according to the invention vs. pre-treatment using either an organic acid or mineral acid alone. Tests A to C were each performed according to the general procedure described above. Test A was performed in the absence of any citric acid. Test B was performed in the absence of hydrochloric acid. In Test C, citric acid treatment was followed by treatment with hydrochloric acid. Where citric acid was used, in all cases it was employed in the form of a 2.5% w/v solution. In Test A, the stipe was provided in the form of dried, flaked L. hyperborea, while in Tests B and C, the dried, flaked material was further ground to give a fraction with a particle size between 200 and 700 μm. The results in respect of the yield of alginate are set out in Table 11.

TABLE 11

| | Citric acid | Hydrochloric | Yield of |
|---|---|---|---|
| Test | (2.5% w/v) | acid | alginate % |
| A | No | Yes | 20.6 |
| B | Yes | No | 16.5 |
| C | Yes | Yes | 45.9 |

As can be seen from the results in Table 11, the combination of both the organic acid and metal cation exchange treatments results in a significantly increased yield of alginate compared to the use of either treatment alone.

### Example 14—Use of Citric Acid at Different Temperatures

To investigate the effect of varying the citric acid treatment conditions on the extracted alginate, a series of comparative experiments was performed.

In Tests A1 and A2, stipe powder having a particle size of approximately 250 μm was prepared from dried, flaked L. hyperborea from which the leaf and epiphytes had been removed.

In Tests B1 and B2, stipe powder as used in Tests A1 and A2 was mixed in a 50:50 weight ratio with leaf powder prepared by grinding dried flakes of leaf to a particle size of approximately 250 μm.

In Tests C1 and C2, stipe powder as used in Tests A1 and A2 was mixed in a 50:50 weight ratio with leaf powder prepared by grinding dried flakes of leaf obtained from whole dried leaf fronds to a particle size of approximately 250 μm.

All tests were conducted according to the general procedure described above. In Tests A1, B1 and C1 the citric acid treatment was performed at ambient temperature for 60 minutes. In Tests A2, B2 and C2, citric acid treatment was performed at 95-99° C. for 35-40 minutes.

Viscosity of the obtained alginate was measured using a Brookfield type viscometer at 20°° C. Molecular weight, polydispersity index and G and M content were measured according to the methods described in Example 4. The results are set 5 out in Table 12 below.

TABLE 12

| | | | | Molecular | Poly | G | M |
|---|---|---|---|---|---|---|---|
| | Starting | Test | Viscosity | weight | Dispersity | content | content |
| Test | material | conditions | (mPa · s) | (kDa) | index | % | % |
| A1 | Stipe | 1% w/v | 2040 ¹ | 495 | 2.60 | 70 | 30 |
| | powder | citric acid | | | | | |
| | | 25° C. | | | | | |
| | | 60 mins | | | | | |
| A2 | Stipe | 1% w/v | 422 ² | 33 | 1.79 | 77 | 23 |
| | powder | citric acid, | | | | | |
| | | 95-99° C. | | | | | |
| | | 35-40 mins | | | | | |
| B1 | 50/50 | 1% w/v | 1992 ¹ | 624 | 2.25 | 58 | 42 |
| | mixture of | citric acid | | | | | |
| | stipe | 25° C. | | | | | |
| | powder + | 60 mins | | | | | |
| | leaf | | | | | | |
| | powder | | | | | | |
| B2 | 50/50 | 1% w/v | 1730 ² | 43 | 1.95 | 71 | 29 |
| | mixture of | citric acid | | | | | |
| | stipe | 95-99° C. | | | | | |
| | powder + | 35-40 mins | | | | | |
| | leaf | | | | | | |
| | powder | | | | | | |
| C1 | 50/50 | 1% w/v | 897 ¹ | 458 | 3.30 | 63 | 37 |
| | mixture of | citric acid | | | | | |
| | stipe | 25° C. | | | | | |
| | powder + | 60 mins | | | | | |
| | leaf | | | | | | |
| | powder | | | | | | |
| C2 | 50/50 | 1% w/v | 180 ² | 34 | 1.71 | 74 | 26 |
| | mixture of | citric acid | | | | | |
| | stipe | 95-99° C. | | | | | |
| | powder + | 35-40 mins | | | | | |
| | leaf | | | | | | |
| | powder | | | | | | |

¹ measured using a 1% w/v solution
² measured using a 10% w/v solution

From the data in Table 12, a similar trend is observed across all three sets of experiments. Alginate extracted following a higher temperature citric acid pre-treatment has a reduced molecular weight, lower polydispersity index, higher G content and lower M content than alginate extracted from the same starting material but following a lower temperature citric acid pre-treatment. The higher temperature citric acid pre-treatment can therefore be used to obtain G-enriched, low molecular weight alginate having a relatively narrow molecular weight distribution.

Leaf alginate typically has a higher M content than stipe alginate. This is consistent with the G and M contents found for the alginate obtained in Tests A1, B1 and C1, which involve a lower temperature citric acid pre-treatment intended to substantially preserve the native alginate structure. However, it is observed that the high temperature citric acid pre-treatment of a mixture of stipe powder+leaf powder provides alginate having a similar G and M content to that obtained from stipe alginate—in other words, the G content in the leaf alginate is enriched.

The results evidence that the conditions of the organic acid pre-treatment can be adjusted to provide an alginate product having desired properties depending on its intended application.

1. A method for the extraction of alginate from macroalgae, or a part thereof, said method comprising the following steps:
(i) contacting macroalgae, or a part thereof, with an aqueous solution of a weak organic acid;
(ii) subsequently contacting the macroalgae, or part thereof, with an aqueous solution of a mineral acid whereby to form a pre-treated macroalgae material; and
(iii) extracting alginate from said pre-treated macroalgae material.

2. A method as claimed in claim 1, wherein the organic acid has a pKₐ greater than 1.5, preferably a pKₐ in the range from 2 to 6.

3. A method as claimed in claim 1 or claim 2, wherein the organic acid has a pKₐ less than or equal to 3.5.

4. A method as claimed in any one of claims 1 to 3, wherein the organic acid is an alpha-hydroxy acid, preferably a food grade alpha-hydroxy acid.

5. A method as claimed in claim 1, wherein the organic acid is selected from the group consisting of lactic acid, malic acid, tartaric acid, citric acid, ascorbic acid, glycolic acid, acetic acid and formic acid.

6. A method as claimed in claim 1, wherein the organic acid is selected from the group consisting of lactic acid, malic acid, tartaric acid, citric acid, ascorbic acid, and glycolic acid.

7. A method as claimed in claim 1, wherein the organic acid is citric acid or malic acid.

8. A method as claimed in claim 1, wherein the organic acid is citric acid.

9. A method as claimed in any one of the preceding claims, wherein the concentration of organic acid is from 0.1 to 10.0% w/v.

10. A method as claimed in any one of the preceding claims, wherein step (i) is carried out at a temperature in the range of from 10 to 100° C., preferably at ambient temperature.

11. A method as claimed in any one of the preceding claims, wherein the mineral acid is hydrochloric acid or sulphuric acid.

12. A method as claimed in any one of the preceding claims, wherein step (ii) is carried out for a period of up to 60 minutes.

13. A method as claimed in any one of the preceding claims, wherein step (iii) comprises the step of contacting said pre-treated macroalgae material with an alkaline solution.

14. A method as claimed in claim 13, wherein the alkaline solution is sodium carbonate and/or sodium hydroxide.

15. A method as claimed in claim 14, wherein the alkaline solution is sodium carbonate and is employed at a concentration in the range from 0.05 to 4%, for example 0.1 to 0.5%.

16. A method as claimed in any one of the preceding claims, further comprising the step of contacting the macroalgae, or a part thereof with a calcium chloride solution prior to step (i), preferably wherein the concentration of the calcium chloride solution is in the range from 0.5 to 10% w/v.

17. A method as claimed in any one of the preceding claims, wherein the macroalgae is selected from the group consisting of: Laminaria spp, Ascophyllumspp, Durvillaea spp, Ecklonia spp, Lessonia spp, Macrocytis spp and Sargassumspp.

18. A method as claimed in claim 17, wherein the macroalgae is Laminaria hyperborea.

19. A method as claimed in any one of the preceding claims, wherein the macroalgae part is stipe, leaf or a combination thereof.

20. A method as claimed in claim 19, wherein the stipe is unpeeled.

21. A method as claimed in any one of the preceding claims, which does not include any step of treating the macroalgae or part thereof with formaldehyde or any derivative of formaldehyde.

22. A method as claimed in any one of the preceding claims, which does not include any step of treating the macroalgae or part thereof with a bleaching agent.

23. Alginate or an alginate derivative obtained, obtainable, or directly obtained, from the process as claimed in any one of claims 1 to 22.

24. Alginate or an alginate derivative as claimed in claim 23 which is substantially free from formaldehyde or any derivative of formaldehyde and/or substantially free from a chemical bleaching agent.

25. Alginate or an alginate derivative as claimed in claim 23 or claim 24 having one or more of the following characteristics:
a molecular weight of at least 300 kDa;
a polydispersity index in the range from 1.2 to 3.5, preferably from 1.2 to 1.5; and
an α-L-guluronate (G) content in the range from 55 to 80%, preferably from 60 to 80%.

26. A product comprising an alginate or alginate derivative as claimed in any one of claims 23 to 25, preferably wherein said product is a food product, pharmaceutical, medical product, nutraceutical or health product, a product for use in agriculture, a cosmetic product, or product for use in the paper and textiles industries.
